(19) United States
(12) Patent Application Publication
(10) Pub. No.: US 2014/0036120 A1
(43) Pub. Date: Feb. 6, 2014

(54) IMAGE PICKUP DEVICE

(71) Applicant: OLYMPUS CORPORATION, Tokyo (JP)

(72) Inventor: Yoshio Hagihara, Tokyo (JP)

(73) Assignee: OLYMPUS CORPORATION, Tokyo (JP)

(21) Appl. No.: 13/957,116

(22) Filed: Aug. 1, 2013

(30) Foreign Application Priority Data
Aug. 3, 2012 (JP) 2012-173175

(51) Int. Cl. H04N 5/374

(52) U.S. Cl. CPC H04N 5/374
USPC 348/300

(57) ABSTRACT

An image pickup device may include: an image capturing unit; a reference signal generation unit; a row selection unit that selects and controls each unit pixel for every row of the array of the unit pixels; a comparison unit including a differential amplifier unit and a reset unit; a measurement unit that measures a comparison time from a comparison start to a comparison end; and a change unit that includes a switch element and a second capacitive element in which one end of the second capacitive element is connected to the first input terminal and the other end of the second capacitive element is connected to a first voltage source via the switch element at a time of a reset operation by the reset unit and connected to a second voltage source different from the first voltage source via the switch element after the reset operation.

### BACKGROUND OF THE INVENTION

1. Field of the Invention

The present invention relates to an image pickup device.

Priority is claimed on Japanese Patent Application No. 2012-173175, filed Aug. 3, 2012, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

As an image pickup device using an analog-to-digital (AD) conversion method related to an example of the related art, a configuration disclosed in Japanese Unexamined Patent Application, First Publication No. 2006-340044 is known. First, a configuration and operation of the image pickup device disclosed in Japanese Unexamined Patent Application, First Publication No. 2006-340044 will be described.

FIG. 16 illustrates a schematic configuration of a (complementary) metal oxide semiconductor ((C)MOS) image pickup device using an AD conversion method related to an example of the related art disclosed in Japanese Unexamined Patent Application, First Publication No. 2006-340044. An image pickup device 1001 includes an image capturing unit 1002, a vertical selection unit 1012, a read current source unit 1005, an analog unit 1006, a column processing unit 1015, a reference signal generation unit 1016, a horizontal selection unit 1014, an output unit 1017, a change unit 1018, and a timing control unit 1020.

The timing control unit 1020 controls parts such as the vertical selection unit 1012, the read current source unit 1005, the analog unit 1006, the column processing unit 1015, the reference signal generation unit 1016, the horizontal selection unit 1014, and the output unit 1017. The image capturing unit 1002 includes unit pixels 1003 having photoelectric conversion elements arranged in a matrix shape, generates a pixel signal corresponding to the amount of an incident electromagnetic wave, and outputs the pixel signal to a vertical signal line 1013 provided in each column.

Upon driving each unit pixel 1003 of the image capturing unit 1002, the vertical selection unit 1012 controls row addressing or row scanning of the image capturing unit 1002 via a row control line 1011. The horizontal selection unit 1014 controls column addressing or column scanning of a column AD conversion unit 1030 of the column processing unit 1015. The read current source unit 1005 is a current source for reading the pixel signal from the image capturing unit 1002 as a voltage signal. The analog unit 1006 executes amplification or the like, if necessary.

The column processing unit 1015 has the change unit 1018 and the column AD conversion unit 1030 provided in each column of the image capturing unit 1002. The change unit 1018 changes the voltage given to the column AD conversion unit 1030. The column AD conversion unit 1030 converts an analog signal, which is a pixel signal output from each unit pixel 1003 of the image capturing unit 1002 in each column, into digital data, thereby outputs the digital data. The reference signal generation unit 1016 includes, for example, an integral circuit or a digital-to-analog conversion (DAC) circuit, and generates a reference signal Ramp, the level of which varies in an inclined shape according to the passage of time.

Next, a configuration of the column AD conversion unit 1030 will be described. FIG. 17 is a block diagram illustrating a configuration of the column processing unit 1015 including the column AD conversion units 1030. The column AD conversion units 1030 all have the same configuration, and each column AD conversion unit 1030 is configured to have a comparison unit 1031 and a measurement unit 1032.

The comparison unit 1031 is a comparator circuit having a differential amplifier which is generally well known as a basic configuration. The comparison unit 1031 compares a pixel signal output from the unit pixel 1003 of the image capturing unit 1002 to the reference signal Ramp, outputs a high (H) level, for example, when the reference signal Ramp is larger than the pixel signal, and outputs a low (L) level, for example, when the reference signal Ramp is smaller than the pixel signal.

The measurement unit 1032 includes an up/down-counter circuit, and measures a comparison time of the comparison unit 1031 from a comparison start to a comparison end. Thereby, a measurement value of the comparison time corresponding to the magnitude of a pixel signal can be obtained. The horizontal selection unit 1014 includes a shift register, a decoder, or the like, and controls column addressing or column scanning of each column AD conversion unit 1030 in the column processing unit 1015. Thereby, AD-converted digital data is sequentially output to the output unit 1017 by way of a horizontal signal line.

The change unit 1018 includes a switch element. One end of the switch element is connected to an input terminal to which the reference signal Ramp is given between two input terminals of the comparison unit 1031 of every column, and the other end of the switch element is connected to a power supply VDD. The switch element constituting the changing unit 1018 is turned on (activated), so that the input terminal of the comparison unit 1031 to which the reference signal Ramp is given is short-circuited to the power supply VDD.

A comparison operation by the comparison unit 1031 is initiated after voltages of two input terminals of the differential amplifier constituting the comparison unit 1031 are reset (balanced). The change unit 1018 is provided in the image pickup device 1001 to prevent a defect in which an output of the comparison unit 1031 is not inverted, or the output of the comparison unit 1031 is inverted immediately after an input of the reference signal Ramp, by some variation remaining in the voltages of the two input terminals of the differential amplifier constituting the comparison unit 1031 after the reset operation.

Next, an AD conversion operation will be described. A description of a specific operation of the unit pixel 1003 is omitted here, but a reset level and a signal level are output as pixel signals from the unit pixel 1003.

First, the voltages of the two input terminals of the differential amplifier constituting the comparison unit 1031 are reset once reading of the reset level from the unit pixel 1003 is stable. Subsequently, the change unit 1018 applies a predetermined voltage (offset) to an input terminal to which the reference signal Ramp has been given. Thereafter, the comparison unit 1031 compares the reference signal Ramp to the reset level using the predetermined voltage as the voltage of a comparison start, and ends a comparison process at a timing at which the reference signal Ramp has satisfied a predetermined condition with respect to the reset level. The measurement unit 1032 performs measurement in a count-down mode, and a measurement value of a comparison end time becomes digital data at the reset level.

Subsequently, when the signal level from the unit pixel 1003 is read, the reset operation in the comparison unit 1031 and the change operation by the change unit 1018 are not performed. Once the reading of the signal level from the unit pixel 1003 is stable, the comparison unit 1031 compares the reference signal Ramp to the signal level using the predetermined voltage as the voltage of the comparison start, and ends a comparison process at a timing at which the reference signal Ramp has satisfied a predetermined condition with respect to the signal level. The measurement unit 1032 performs measurement in a count-up mode, and a measurement value of the measurement unit 1032 of the comparison end time becomes digital data of a signal component (a signal obtained by subtracting the reset level from the signal level).

As described above, it is possible to AD-convert the pixel signal. In addition, even when some variation remains in the voltages of the two input terminals of the differential amplifier constituting the comparison unit 1031 after the reset operation, the change unit 1018 applies an offset to the input terminal to which the reference signal Ramp has been given, so that the output of the comparison unit 1031 can be reliably inverted during the comparison operation because the voltage of the input terminal to which the reference signal Ramp has been given is higher than the voltage of the input terminal to which the pixel signal has been given.

### SUMMARY

According to a first aspect of the present invention, an image pickup device may include: an image capturing unit in which a plurality of unit pixels having photoelectric conversion elements are arranged in a matrix shape, the image capturing unit being configured to output an analog signal to a column signal line corresponding to each column of an array of the unit pixels; a reference signal generation unit configured to generate a reference signal to be increased or decreased with passage of time; a row selection unit configured to select and control each unit pixel of the image capturing unit for every row of the array of the unit pixels; a comparison unit that includes a differential amplifier unit and a reset unit, the differential amplifier unit including a first input terminal electrically connected to the column signal line via a first capacitive element and a second input terminal electrically connected to the reference signal generation unit, the differential amplifier unit being configured to compare a voltage of the first input terminal to a voltage of the second input terminal, the reset unit being configured to reset the voltages of the first and second input terminals; a measurement unit configured to measure a comparison time of the comparison unit from a comparison start to a comparison end; and a change unit that includes a switch element and a second capacitive element in which one end of the second capacitive element is connected to the first input terminal and the other end of the second capacitive element is connected to a first voltage source via the switch element at a time of a reset operation by the reset unit and connected to a second voltage source different from the first voltage source via the switch element after the reset operation by the reset unit, the change unit being configured to apply an offset corresponding to voltages of the first voltage source and the second voltage source to the first input terminal so that a voltage difference between the first and second input terminals becomes a voltage that ensures a comparison operation by the comparison unit. The plurality of unit pixels arranged in the image capturing unit may include unit pixels included in a first pixel group and unit pixels included in a second pixel group different from the first pixel group. The offset to be applied to the first input terminal of the comparison unit connected to the column signal line corresponding to one column of an array of the unit pixels included in the first pixel group may be different from the offset to be applied to the first input terminal of the comparison unit connected to the column signal line corresponding to one column of an array of the unit pixels included in the second pixel group.

According to a second aspect of the present invention, an image pickup device may include: an image capturing unit in which a plurality of unit pixels having photoelectric conversion elements are arranged in a matrix shape, the image capturing unit being configured to output an analog signal to a column signal line corresponding to each column of an array of the unit pixels; a reference signal generation unit configured to generate a reference signal to be increased or decreased with passage of time; a row selection unit configured to select and control each unit pixel of the image capturing unit for every row of the array of the unit pixels; a comparison unit that includes a differential amplifier unit and a reset unit, the differential amplifier unit including a first input terminal electrically connected to the column signal line and a second input terminal electrically connected to the reference signal generation unit via a first capacitive element, the differential amplifier being configured to compare a voltage of the first input terminal to a voltage of the second input terminal, the reset unit being configured to reset the voltages of the first and second input terminals; a measurement unit configured to measure a comparison time of the comparison unit from a comparison start to a comparison end; and a change unit that includes a switch element and a second capacitive element in which one end of the second capacitive element is connected to the second input terminal and the other end of the second capacitive element is connected to a first voltage source via the switch element at a time of a reset operation by the reset unit and connected to a second voltage source different from the first voltage source via the switch element after the reset operation by the reset unit, the change unit applying an offset corresponding to voltages of the first voltage source and the second voltage source to the second input terminal so that a voltage difference between the first and second input terminals becomes a voltage which ensures a comparison operation by the comparison unit. The plurality of unit pixels arranged in the image capturing unit may include unit pixels included in a first pixel group and unit pixels included in a second pixel group different from the first pixel group. The offset to be applied to the second input terminal of the comparison unit connected to the column signal line corresponding to one column of an array of the unit pixels included in the first pixel group may be different from the offset to be applied to the second input terminal of the comparison unit connected to the column signal line corresponding to one column of an array of the unit pixels included in the second pixel group.

According to a third aspect of the present invention, the image pickup device according to the first aspect or the second aspect, a capacitance value of the second capacitive element provided in the change unit related to the comparison unit connected to the column signal line corresponding to the one column of the array of the unit pixels included in the first pixel group may be different from a capacitance value of the second capacitive element provided in the change unit related to the comparison unit connected to the column signal line corresponding to the one column of the array of the unit pixels included in the second pixel group.

According to a fourth aspect of the present invention, the image pickup device according to the first aspect or the second aspect, a voltage value of at least one voltage source of the first and second voltage sources connected to the other end of the second capacitive element provided in the change unit related to the comparison unit connected to the column signal line corresponding to the one column of the array of the unit pixels included in the first pixel group may be different from a voltage value of at least one voltage source of the first and second voltage sources connected to the other end of the second capacitive element provided in the change unit related to the comparison unit connected to the column signal line corresponding to the one column of the array of the unit pixels included in the second pixel group.

According to a fifth aspect of the present invention, in the image pickup device according to the first aspect, the second voltage source may be the analog signal.

According to a sixth aspect of the present invention, in the image pickup device according to the second aspect, the second voltage source may be the reference signal.

According to a seventh aspect of the present invention, an image pickup device may include: an image capturing unit in which a plurality of unit pixels having photoelectric conversion elements are arranged in a matrix shape, the image capturing unit being configured to output an analog signal to a column signal line corresponding to each column of an array of the unit pixels; a reference signal generation unit configured to generate a reference signal to be increased or decreased with passage of time; a row selection unit configured to select and control each unit pixel of the image capturing unit for every row of the array of the unit pixels; a comparison unit that includes a differential amplifier unit and a reset unit, the differential amplifier unit including a first input terminal electrically connected to the column signal line via a first capacitive element and a second input terminal electrically connected to the reference signal generation unit, the differential amplifier being configured to compare a voltage of the first input terminal to a voltage of the second input terminal, the reset unit being configured to reset the voltages of the first and second input terminals; a measurement unit configured to measure a comparison time of the comparison unit from a comparison start to a comparison end; and a change unit that includes a switch element in which one end of the switch element is connected to the first input terminal and the other end of the switch element is connected to a voltage source after a reset operation by the reset unit, the changing unit being configured to apply an offset corresponding to a voltage of the voltage source to the first input terminal so that a voltage difference between the first and second input terminals becomes a voltage which ensures a comparison operation by the comparison unit. The plurality of unit pixels arranged in the image capturing unit may include unit pixels included in a first pixel group and unit pixels included in a second pixel group different from the first pixel group. The offset to be applied to the first input terminal of the comparison unit connected to the column signal line corresponding to one column of an array of the unit pixels included in the first pixel group may be different from the offset to be applied to the first input terminal of the comparison unit connected to the column signal line corresponding to one column of an array of the unit pixels included in the second pixel group.

According to an eighth aspect of the present invention, an image pickup device may include: an image capturing unit in which a plurality of unit pixels having photoelectric conversion elements are arranged in a matrix shape, the image capturing unit being configured to output an analog signal to a column signal line corresponding to each column of an array of the unit pixels; a reference signal generation unit configured to generate a reference signal to be increased or decreased with passage of time; a row selection unit configured to select and control each unit pixel of the image capturing unit for every row of the array of the unit pixels; a comparison unit that includes a differential amplifier unit and a reset unit, the differential amplifier unit including a first input terminal electrically connected to the column signal line and a second input terminal electrically connected to the reference signal generation unit via a first capacitive element, the differential amplifier being configured to compare a voltage of the first input terminal to a voltage of the second input terminal, the reset unit being configured to reset the voltages of the first and second input terminals; a measurement unit configured to measure a comparison time of the comparison unit from a comparison start to a comparison end; and a change unit that includes a switch element in which one end of the switch element is connected to the second input terminal and the other end of the switch element is connected to a voltage source after a reset operation by the reset unit, the change unit applying an offset corresponding to a voltage of the voltage source to the second input terminal so that a voltage difference between the first and second input terminals becomes a voltage which ensures a comparison operation by the comparison unit. The plurality of unit pixels arranged in the image capturing unit may include unit pixels included in a first pixel group and unit pixels included in a second pixel group different from the first pixel group. The offset to be applied to the second input terminal of the comparison unit connected to the column signal line corresponding to one column of an array of the unit pixels included in the first pixel group may be different from the offset to be applied to the second input terminal of the comparison unit connected to the column signal line corresponding to one column of an array of the unit pixels included in the second pixel group.

According to a ninth aspect of the present invention, the image pickup device according to the seventh aspect or the eighth aspect, a voltage value of the voltage source connected to the other end of the switch element provided in the change unit related to the comparison unit connected to the column signal line corresponding to one column of an array of the unit pixels included in the first pixel group may be different from a voltage value of the voltage source connected to the other end of the switch element provided in the change unit related to the comparison unit connected to the column signal line corresponding to one column of an array of the unit pixels included in the second pixel group.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a configuration of an image pickup device in accordance with a first preferred embodiment of the present invention;

FIG. 2 is a block diagram illustrating a configuration of a column processing unit provided in the image pickup device in accordance with the first preferred embodiment of the present invention;

FIG. 3 is a diagram illustrating configurations of a comparison unit and a change unit provided in the image pickup device in accordance with the first preferred embodiment of the present invention and voltage variations in input terminals of the comparison unit;

FIG. 4 is a diagram illustrating voltage variations in the input terminals of the comparison unit provided in the image pickup device in accordance with the first preferred embodiment of the present invention;

FIG. 5 is a block diagram illustrating a configuration of a column processing unit provided in an image pickup device in accordance with a second preferred embodiment of the present invention;

FIG. 6 is a diagram illustrating configurations of a comparison unit and a change unit provided in the image pickup device in accordance with the second preferred embodiment of the present invention and voltage variations in input terminals of the comparison unit;

FIG. 7 is a diagram illustrating voltage variations in the input terminals of the comparison unit provided in the image pickup device in accordance with the second preferred embodiment of the present invention;

FIG. 8 is a block diagram illustrating a configuration of a column processing unit provided in an image pickup device in accordance with a third preferred embodiment of the present invention;

FIG. 9 is a diagram illustrating configurations of a comparison unit and a change unit provided in the image pickup device in accordance with the third preferred embodiment of the present invention and voltage variations in input terminals of the comparison unit;

FIG. 10 is a block diagram illustrating a configuration of a column processing unit provided in an image pickup device in accordance with a fourth preferred embodiment of the present invention;

FIG. 11 is a diagram illustrating configurations of a comparison unit and a change unit provided in the image pickup device in accordance with the fourth preferred embodiment of the present invention and voltage variations in input terminals of the comparison unit;

FIG. 12 is a block diagram illustrating a configuration of a column processing unit provided in an image pickup device in accordance with a fifth preferred embodiment of the present invention;

FIG. 13 is a diagram illustrating configurations of a comparison unit and a change unit provided in the image pickup device in accordance with the fifth preferred embodiment of the present invention and voltage variations in input terminals of the comparison unit;

FIG. 14 is a block diagram illustrating a configuration of a column processing unit provided in an image pickup device in accordance with a sixth preferred embodiment of the present invention;

FIG. 15 is a diagram illustrating configurations of a comparison unit and a change unit provided in the image pickup device in accordance with the sixth preferred embodiment of the present invention and voltage variations in input terminals of the comparison unit;

FIG. 16 is a block diagram illustrating a configuration of an image pickup device of the related art; and

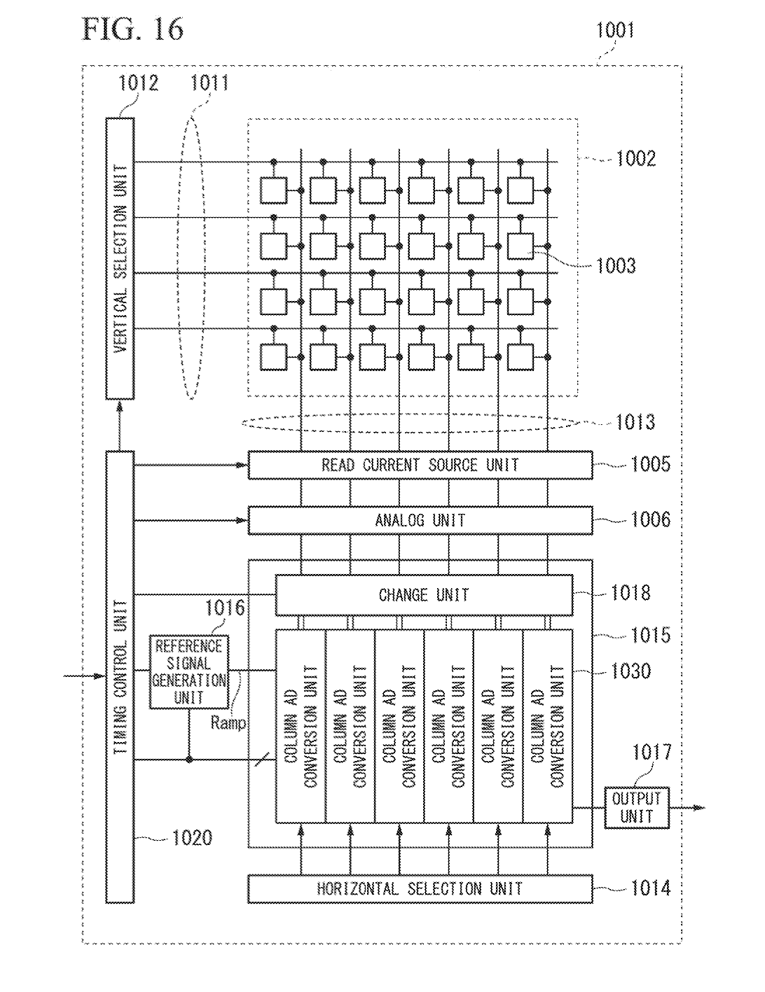

FIG. 17 is a block diagram illustrating a configuration of a column processing unit provided in the image pickup device of the related art.

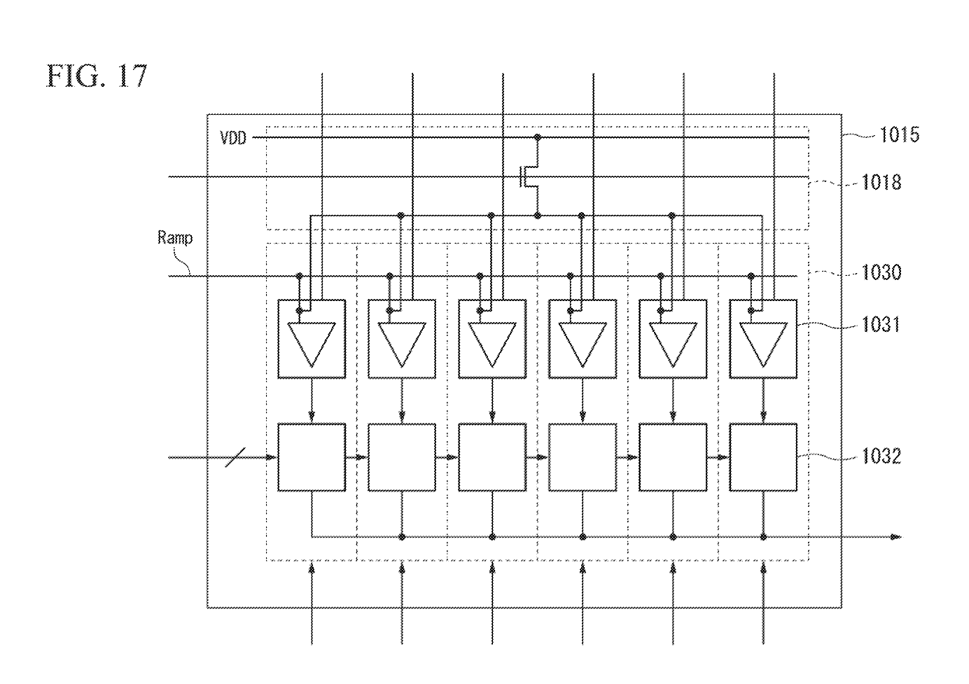

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

### First Preferred Embodiment

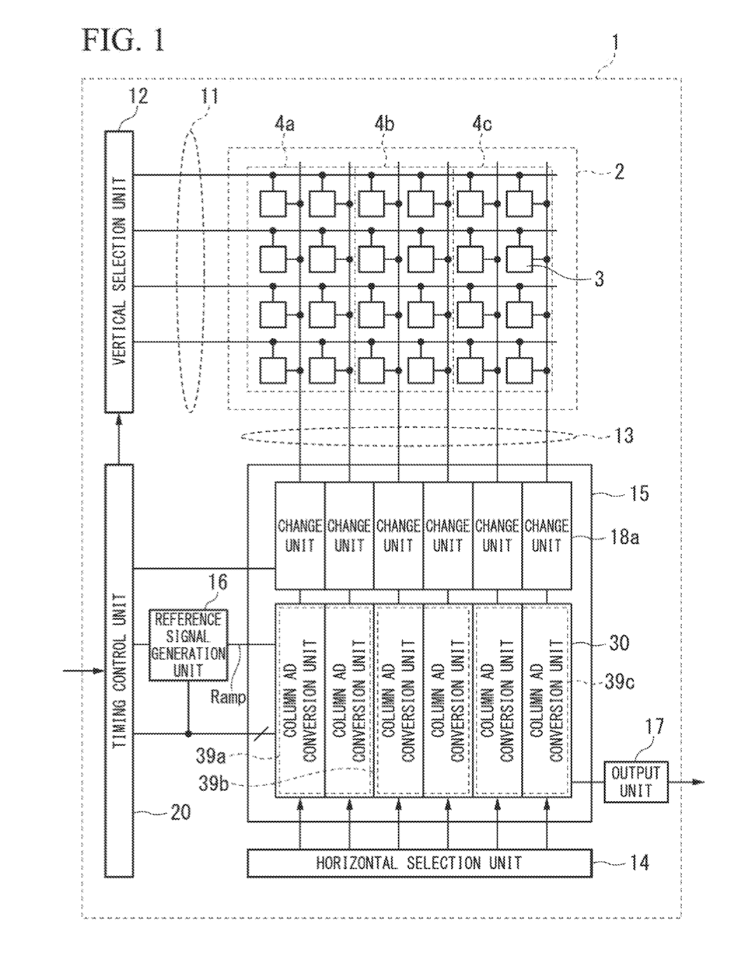

First, a first preferred embodiment of the present invention will be described. FIG. 1 illustrates an example of a configuration of a (C)MOS image pickup device in accordance with the first preferred embodiment of the present invention. The image pickup device 1 illustrated in FIG. 1 includes an image capturing unit 2, a vertical selection unit 12, a column processing unit 15, a reference signal generation unit 16, a change unit 18a, a horizontal selection unit 14, an output unit 17, and a timing control unit 20.

The image capturing unit 2 has a plurality of unit pixels 3 arranged in a matrix shape to generate and output pixel signals corresponding to the amounts of incident electromagnetic waves. The vertical selection unit 12 selects each row of the image capturing unit 2. The reference signal generation unit 16 generates a reference signal Ramp (ramp wave) of which the level varies in an inclined shape with the passage of time. The column processing unit 15 is connected to the reference signal generation unit 16. The horizontal selection unit 14 reads digital data after AD conversion to a horizontal signal line. The output unit 17 outputs the digital data read by the horizontal selection unit 14 to a subsequent-stage circuit. The timing control unit 20 controls each part.

Although the image capturing unit 2 including unit pixels 3 of 4 rows×6 columns is illustrated for simplicity in FIG. 1, several tens or several tens of thousands of unit pixels 3 are actually arranged in each row or column of the image capturing unit 2. Although not illustrated, the unit pixel 3 constituting the image capturing unit 2 includes a photoelectric conversion element such as a photodiode, photo gate, photo transistor and a transistor circuit.

Hereinafter, each part will be described in further detail. In the image capturing unit 2, the unit pixels 3 of 4 rows and 6 columns are two-dimensionally arranged and a row control line 11 is wired for every row in a pixel array of the 4 rows and the 6 columns. One end of the row control line 11 is connected to each output end corresponding to each row of the vertical selection unit 12. The vertical selection unit 12 includes a shift register, a decoder, or the like, and controls row addressing or row scanning of the image capturing unit 2 via the row control line 11 when each unit pixel 3 of the image capturing unit 2 is driven. In addition, a vertical signal line 13 is wired for every column in the pixel array of the image capturing unit 2.

The column processing unit 15 has a column AD conversion unit 30 and the change unit 18a provided for every pixel column of the image capturing unit 2, that is, for every vertical signal line 13. The column AD conversion unit 30 converts an analog pixel signal read through the vertical signal line 13 for every pixel column from each unit pixel 3 of the image capturing unit 2 into digital data. The change unit 18a changes the voltage given to the column AD conversion unit 30.

The unit pixel 3 of the image capturing unit 2 is included in one of three pixel groups 4a, 4b, and 4c. That is, a plurality of unit pixels 3 constituting the image capturing unit 2 include unit pixels 3 included in the pixel group 4a, unit pixels 3 included in the pixel group 4b, and unit pixels 3 included in the pixel group 4c. As illustrated in FIG. 1, unit pixels 3 of first and second columns are included in the pixel group 4a, unit pixels 3 of third and fourth columns are included in the pixel group 4b, and unit pixels 3 of fifth and sixth columns are included in the pixel group 4c.

A pixel signal output from the unit pixel 3 included in the pixel group 4a is input to the column AD conversion unit 30 arranged in an area 39a corresponding to the pixel group 4a via the vertical signal line 13. A pixel signal output from the unit pixel 3 included in the pixel group 4b is input to the column AD conversion unit 30 arranged in an area 39b corresponding to the pixel group 4b via the vertical signal line 13. A pixel signal output from the unit pixel 3 included in the pixel group 4c is input to the column AD conversion unit 30 arranged in an area 39c corresponding to the pixel group 4c via the vertical signal line 13.

Although the column AD conversion unit 30 is configured to be arranged for a pixel column of the image capturing unit 2 in a one-to-one correspondence relationship in this example, this is only an exemplary example and the present invention is not limited to the above-described layout relationship. For example, one column AD conversion unit 30 may be arranged for a plurality of pixel columns, and the one column AD conversion unit 30 may be configured to be used by time division among the plurality of pixel columns. The column processing unit 15 constitutes an AD conversion circuit, which converts an analog pixel signal read from the unit pixel 3 of a selected pixel row of the image capturing unit 2 into digital pixel data, along with the reference signal generation unit 16 as will be described later. Details of the column AD conversion unit 30 will be described later.

The reference signal generation unit 16 generates so-called ramp waves, the level of which varies in an inclined shape with the passage of time according to control by the control unit 20, and supplies the ramp waves as a reference signal Ramp to the column AD conversion unit 30 via a reference signal line.

The horizontal selection unit 14 includes a shift register, a decoder, or the like, and controls column addressing or column scanning of the column AD conversion unit 30 of the column processing unit 15. According to control by the horizontal selection unit 14, digital data after AD conversion by the column AD conversion unit 30 is read to the output unit 17 via the horizontal signal line in order.

The timing control unit 20 includes a functional block of a timing generator (TG), which supplies a clock or a pulse signal of a predetermined timing necessary for an operation of each part such as the vertical selection unit 12, the change unit 18a, the reference signal generation unit 16, the column processing unit 15, the horizontal selection unit 14, or the output unit 17, and a functional block for communicating with the TG.

In the output unit 17, signal processing functions, for example, black level adjustment, column variation correction, color processing, and the like, may be embedded in addition to a buffering function. Furthermore, in the output unit 17, n-bit parallel digital data may be converted into serial data to be output.

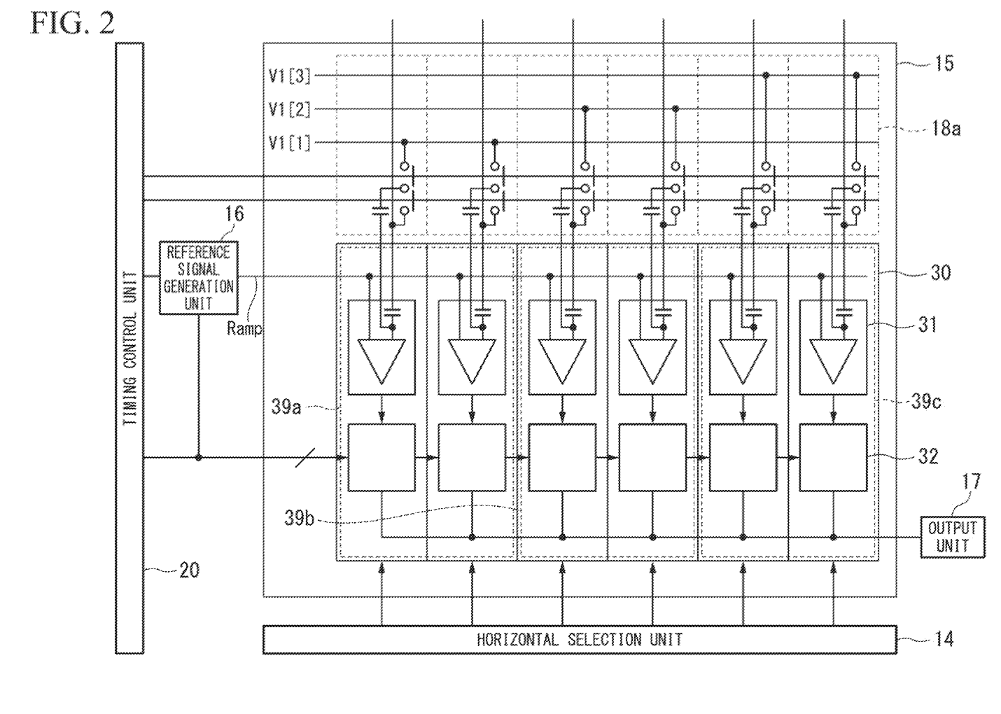

Next, configurations of the column AD conversion unit 30 and the change unit 18a will be described. FIG. 2 is a block diagram illustrating an example of a configuration of the column processing unit 15 including the column AD conversion unit 30 and the change unit 18a. The column AD conversion unit 30 and the change unit 18a are provided for every column. In FIGS. 1 and 2, 6 column AD conversion units 30 and 6 change units 18a are provided. The respective column AD conversion units 30 have the same configuration. In addition, the respective change units 18a have the same configuration except for connected voltage sources.

The column AD conversion unit 30 generates a pulse signal having a magnitude (pulse width) of a time-axis direction corresponding to each magnitude of a reset level or a signal level by comparing an analog pixel signal read from each unit pixel 3 of the image capturing unit 2 through the vertical signal line 13 to a reference signal Ramp given from the reference signal generation unit 16. Accordingly, AD conversion is performed by converting data corresponding to a period of the pulse width of the pulse signal into digital data corresponding to the magnitude of the pixel signal.

Hereinafter, details of the configurations of the column AD conversion unit 30 and the change unit 18a will be described. The column AD conversion unit 30 includes a comparison unit 31 and a measurement unit 32.

The comparison unit 31 converts a magnitude of a pixel signal into information of a time-axis direction (or a pulse width of a pulse signal) by comparing a signal voltage corresponding to an analog pixel signal output from the unit pixel 3 of the image capturing unit 2 through the vertical signal line 13 given to the first input terminal to the reference signal Ramp supplied from the reference signal generation unit 16 given to the second input terminal. For example, a comparison output of the comparison unit 31 has an H level when a ramp voltage of the reference signal Ramp is greater than the signal voltage, and has an L level when the ramp voltage is equal to or less than the signal voltage.

The measurement unit 32 includes, for example, an n-bit up/down-counter circuit, so as to measure a comparison time of the comparison unit 31 from a comparison start to a comparison end. For example, n bits are 10 bits. In addition, the case in which n bits are 10 bits is exemplary, and n may be the number of bits (for example, 8) less than 10 or the number of bits (for example, 12) greater than 10. It is not necessary to limit the measurement unit 32 to an up/down counter.

The change unit 18a includes a capacitive element and a switch element. One end of the capacitive element is connected to the first input terminal of the comparison unit 31, and the other end of the capacitive element is connected to a voltage source V1[n] (n: 1 to 3) (first voltage source) and the vertical signal line 13 through which an analog signal (second voltage source) from the unit pixel 3 is supplied via the switch element. The voltage source V1[1] supplies a power supply voltage (voltage value: V_{1[}1]) to the change unit 18a corresponding to the column AD conversion unit 30 of the area 39a. The voltage source V1[2] supplies a power supply voltage (voltage value: V_{1[}2]) to the change unit 18a corresponding to the column AD conversion unit 30 of the area 39b. The voltage source V1[3] supplies a power supply voltage (voltage value: V_{1[}3]) to the change unit 18a corresponding to the column AD conversion unit 30 of the area 39c. The relationship of the voltage values V_{1[n]} (n: 1 to 3), for example, is V_{1[}1]<V_{1[}2]<V_{1[}3]. Furthermore, these are exemplary examples and the present invention is not limited thereto.

Next, an operation of this example will be described. Here, although the description of a specific operation of the unit pixel 3 is omitted, a reset level and a signal level are output by the unit pixel 3 as is well known.

The AD conversion is performed as follows. For example, ramp waves (a reference signal Ramp) falling at a predetermined tilt are compared to a voltage of a reset level or a signal level as a pixel signal from the unit pixel 3. A period until a signal corresponding to the reset level or the signal level is consistent with the ramp waves (ramp voltage) from a point in time when ramp waves for use in the comparison process have been generated is measured, for example, according to a reference clock, so that digital data corresponding to a magnitude of the reset level or the signal level is obtained.

Here, a reset level including noise of a pixel signal in a first read operation is read as an analog pixel signal from each unit pixel 3 of a selected row of the image capturing unit 2, and then a signal level is read in a second read operation. Accordingly, the reset level and the signal level are input to the column AD conversion unit 30 through the vertical signal line 13 in time series.

### (First Read)

Once the first read operation from the unit pixel 3 of an arbitrary pixel row to the vertical signal line 13 is stable, a reset operation of the comparison unit 31 is performed. Subsequently, the change unit 18a changes a voltage of the first input terminal of the comparison unit 31 to which the reset level has been given to a predetermined voltage lower than the reset level. At this time, an offset that differs according to each of the areas 39a, 39b, and 39c is applied to the first input terminal of the comparison units 31 of the column AD conversion units 30 of each of the areas 39a, 39b, and 39c.

Thereafter, the timing control unit 20 supplies control data of ramp wave generation to the reference signal generation unit 16. Upon receipt of the control data, the reference signal generation unit 16 outputs ramp waves (a reference signal Ramp) of which the waveform varies with time in an overall ramp shape as a comparison voltage given to the second input terminal of the comparison unit 31. The comparison unit 31 compares the voltage of the second input terminal to which the reference signal Ramp has been given from the reference signal generation unit 16 to the voltage of the first input terminal to which the reset level has been given, and inverts a comparison output when the two voltages are substantially the same.

The measurement unit 32 starts measurement in the count-down mode based on the comparison start by the comparison unit 31, and retains a measurement value at a point in time at which the comparison output of the comparison unit 31 has been inverted. That is, the measurement unit 32 retains digital data corresponding to the reset level. The timing control unit 20 stops a supply of control data to the reference signal generation unit 16 and an output of a reference clock when a predetermined period has elapsed. Thereby, the reference signal generation unit 16 stops generation of the reference signal Ramp.

### (Second Read)

Subsequently, during the second read operation, a signal level corresponding to an amount of incident light of each unit pixel 3 is read. During the second read operation, the reset operation of the comparison unit 31 and the change operation by the change unit 18a are not performed.

Once the second read operation from the unit pixel 3 of the arbitrary pixel row to the vertical signal line 13 is stable, the timing control unit 20 supplies control data of ramp wave generation to the reference signal generation unit 16. Upon receipt of the control data, the reference signal generation unit 16 outputs a reference signal Ramp. The comparison unit 31 compares the voltage of the second input terminal to which the reference signal Ramp has been given from the reference signal generation unit 16 to the voltage of the first input terminal to which the signal level has been given, and inverts a comparison output when the two voltages are substantially the same.

The measurement unit 32 starts measurement in the count-up mode based on the comparison start by the comparison unit 31, and retains a measurement value at a point in time at which the comparison output of the comparison unit 31 has been inverted. That is, the measurement unit 32 retains digital data corresponding to a signal component obtained by subtracting the reset level from the signal level (correlated double sampling (CDS) processing). The timing control unit 20 stops supply of control data to the reference signal generation unit 16 and output of the reference clock when a predetermined period has elapsed. Thereby, the reference signal generation unit 16 stops generation of the reference signal Ramp.

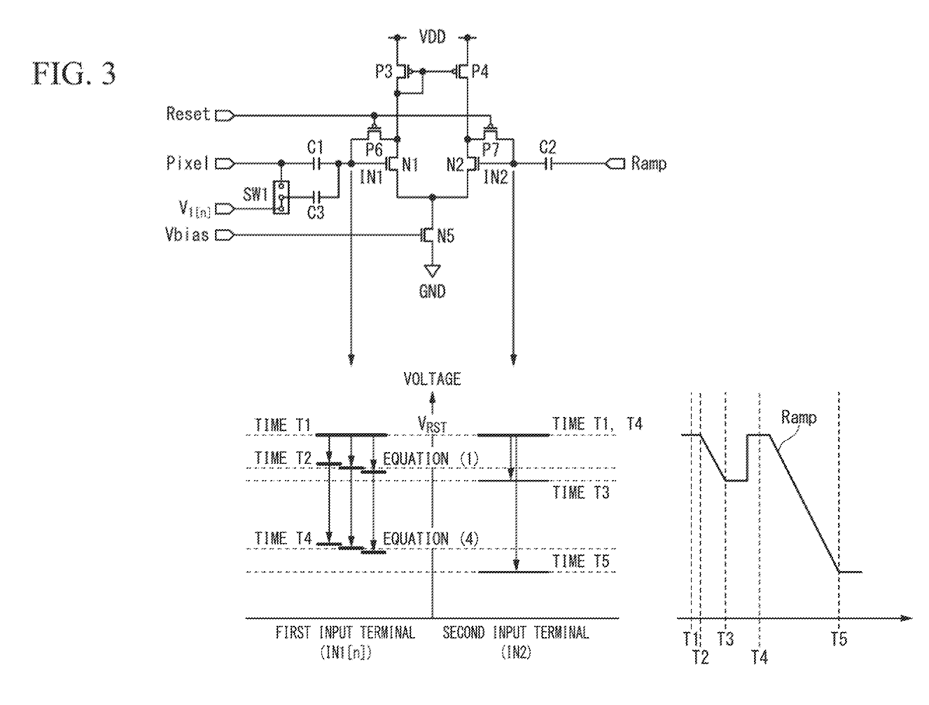

Next, details of configurations of the comparison unit 31 and the change unit 18a and voltage variations in the input terminals of the comparison unit 31 will be described. FIG. 3 illustrates an example of specific circuit configurations of the comparison unit 31 and the change unit 18a. Hereinafter, the circuit configurations of this example will be described.

In FIG. 3, the differential amplifier within the comparison unit 31 includes transistors N1 and N2 including n-type MOSs (NMOSs), the sources of which are commonly connected, transistors P3 and P4 including p-type MOSs (PMOSs) connected between drains of the transistors N1 and N2 and a power supply VDD and of which gates are commonly connected, and a current source N5 of an NMOS connected between a node commonly connected to sources of the transistors N1 and N2 and a ground GND.

In the differential amplifier, transistors P6 and P7 include PMOSs each connected between gates and drains of the transistors N1 and N2. The transistors P6 and P7 are in an ON state when a low-active reset pulse Reset is given from the timing control unit 20 to each gate, and short-circuit the gates and the drains of the transistors N1 and N2, and function as reset units that reset voltages of the gates of the transistors N1 and N2, that is, voltages of two input terminals IN1 and IN2 of the differential amplifier.

The gates of the transistors N1 and N2 are each connected to one ends of capacitive elements C1 and C2 for cutting a direct current (DC) level. A pixel signal Pixel output from each unit pixel 3 of the image capturing unit 2 is given to the other end of the capacitive element C1 (first capacitive element). A reference signal Ramp from the reference signal generation unit 16 is given to the other end of the capacitive element C2.

The change unit 18a includes a capacitive element C3 (second capacitive element) and a switch element SW1. One end of the capacitive element C3 is connected to the gate of the transistor N1, and the other end of the capacitive element C3 is connected to a first terminal of the switch element SW1. A second terminal of the switch element SW1 is connected to the voltage source V1[n] (n: 1 to 3), and a third terminal of the switch element SW1 is connected to the other end of the capacitive element C1. According to a control signal (not illustrated) from the timing control unit 20, the switch element SW1 performs switching between a state in which the voltage source V1[n] has been connected to the other end of the capacitive element C3 by short-circuiting the first terminal and the second terminal and a state in which the other end of the capacitive element C1 has been connected to the other end of the capacitive element C3 by short-circuiting the first terminal and the third terminal. In addition, a bias voltage Vbias for controlling a current value is given to the gate of the current source N5.

Hereinafter, an operation of this example will be described. Here, a voltage of the voltage source V1[n] is represented by V_{1[n]}, a reset-level voltage is represented by V_{R} (here, V_{R}<V_{1[n]}), a signal-level voltage is represented by V_{S} (V_{S}≦V_{R}), a capacitance value of the capacitive element C1 is represented by C₁, and a capacitance value of the capacitive element C3 is represented by C₃. In addition, the first input terminal IN1 of the differential amplifier connected to the voltage source V1[n] via the capacitive element C3 and the switch element SW1 is represented by a first input terminal IN1[n] (n: 1 to 3). In FIG. 3, voltage variations of the first input terminal IN1[n] and the second input terminal IN2 of the differential amplifier within the comparison unit 31 and a waveform of the reference signal Ramp are illustrated.

Once the reset level serving as the pixel signal Pixel from the unit pixel 3 is given to the first input terminal IN1[n] and the reference signal Ramp given from the reference signal generation unit 16 to the second input terminal IN2 is stable, the timing control unit 20 activates a reset pulse Reset (low active) before the comparison start of the comparison unit 31. Thereby, the transistors P6 and P7 are in the ON state, the gates and the drains of the transistors N1 and N2 are short-circuited, and the voltages of the two input terminals are reset by designating operation points of the transistors N1 and N2 as drain voltages. During the reset operation, the other end of the capacitive element C3 is connected to the voltage source V1[n] through the switch element SW1.

At the operation points determined by the reset operation, offset components of the voltages of the two input terminals of the differential amplifier, that is, the gate voltages of the transistors N1 and N2, are almost canceled. That is, the voltages of the two input terminals of the differential amplifier are reset to be substantially the same voltage V_{RST}. At this time (time T1), the voltage of the first input terminal IN1[n] is V_{RST} and the voltage of the second input terminal IN2 is V_{RST}. After the reset operation, the transistors P6 and P7 are in the OFF state.

Subsequently, the switch element SW1 connects the other end of the capacitive element C3 to the other end of the capacitive element C1, so that the voltage of the first input terminal IN1[n] to which the pixel signal Pixel is given, that is, the gate voltage of the transistor N1, is reduced and changed from the voltage V_{RST} to a predetermined voltage. Because the voltage of the other end of the capacitive element C3 is varied from V_{1[n]} to V_{R} by (V_{R}−V_{1[n]}), the voltage V_{IN1[}n] of the first input terminal IN1[n] at this time (time T2) is represented by the following Equation (1).

$${V}_{IN 1 [ 1 ]} = {V}_{RST} + \frac{{C}_{3}}{{C}_{1} + {C}_{3}} \times ( {V}_{R} - {V}_{1 [ n ]} ) \qquad ( 1 )$$

Because V_{R}<V_{1[n]} even when some variation remains in the voltages of the two input terminals of the differential amplifier constituting the comparison unit 31 after the reset operation of the comparison unit 31, the voltage (Equation (1)) of the first input terminal IN1[n] at the initiation of comparison in the comparison unit 31 according to the first read operation is lower than the voltage V_{RST} of the second input terminal IN2. As illustrated in FIG. 3, the ramp wave, which decreases with the passage of time, is given as the reference signal Ramp, so that the output of the comparison unit 31 can be reliably inverted during the comparison operation and the comparison operation by the comparison unit 31 can be ensured.

After time T2, the ramp waves are given as the reference signal Ramp to the second input terminal IN2. At the timing at which the voltage of the second input terminal IN2 to which the ramp waves have been given is substantially consistent with the voltage of the first input terminal IN1[n], the comparison output of the comparison unit 31 is inverted. At a time (time T3) when a predetermined period has elapsed after the input of the ramp waves to the second input terminal IN2 has been initiated, the reference signal generation unit 16 stops the ramp wave generation.

After the reset operation of the comparison unit 31, the voltage related to the second term of the right side of Equation (1) is applied as the offset for the first input terminals IN1[1], IN1[2], and IN1[3]. Because the voltage values V_{1[}1], V_{1[}2], and V_{1[}3] are different from each other and reset levels output from the unit pixels 3 of the columns are substantially the same, different offsets are applied to the first input terminals IN1[1], IN1[2], and IN1[3]. Accordingly, voltages V_{1[}1], V_{1[}2], and V_{1[}3] (Equation (1)) of the first input terminals IN1[1], IN1[2], and IN at the initiation of comparison by the comparison unit 31 according to the first read operation are different from each other. Thereby, even when the timings of the comparison starts in the comparison units 31 according to the first read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

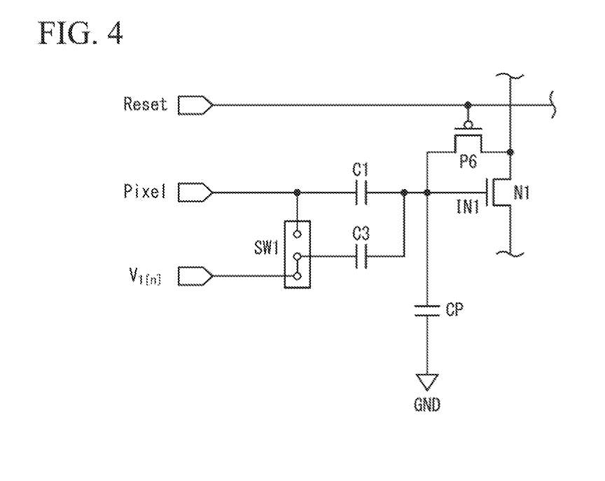

Subsequently, the signal level serving as the pixel signal Pixel from the unit pixel 3 is given to the first input terminal IN1[n]. Hereinafter, the voltage of the first input terminal IN1[n] at a time (time T4) when the signal level is input will be described using FIG. 4. FIG. 4 illustrates only an extracted peripheral configuration of the first input terminal IN1[n]. Hereinafter, a parasitic capacitor CP between the first input terminal IN1[n] and the ground GND will be assumed and described.

At a time (time T2) when the other end of the capacitive element C3 is connected to the other end of the capacitive element C1 by the switch element SW1, the voltage of the other end of the capacitive element C1 to which the reset level is given as the pixel signal Pixel is V_{R}. In addition, at a time (time T4) when the signal level has been input as the pixel signal Pixel, the voltage of the other end of the capacitive element C1 is represented by V_{S}. When voltage variation of the other end of the capacitive element C1 from time T2 to time T4 is represented by ΔV1, ΔV1 is represented by the following Equation (2).

ΔV1=V_{S}−V_{R} (2)

Because the transistor P6 is in the OFF state during the period from time T2 to time T4, an amount of charges accumulated in the capacitive elements C1 and C3 and the parasitic capacitor CP is retained. Thus, when voltage variation of the first input terminal IN1[n] from time T2 to time T4 is represented by ΔV2, ΔV2 is represented by the following Equation (3). Furthermore, the capacitive element C1 and the capacitive element C3 are connected in parallel, and the capacitance value of a sum of the capacitive element C1 and the capacitive element C3 connected in parallel is C_{C} of Equation (3). In Equation (3), C_{P} is a capacitance value of the parasitic capacitor CP.

$$Δ V 2 = \frac{{C}_{C}}{{C}_{C} + {C}_{P}} \times Δ V 1 \qquad ( 3 )$$

When C_{P} is negligible compared to C_{C} (C_{C}>>C_{P}), ΔV2=ΔV1. Because the voltage of the first input terminal IN1[n] at time T2 is represented by Equation (1), the voltage V_{IN1[}1] of the first input terminal IN1[n] at time T4 is represented by the following Equation (4).

$$\begin{matrix}{V}_{IN 1 [ n ]} = {V}_{RST} + \frac{{C}_{3}}{{C}_{1} + {C}_{3}} \times ( {V}_{R} - {V}_{1 [ n ]} ) + Δ V 2 \\ = {V}_{RST} + \frac{{C}_{3}}{{C}_{1} + {C}_{3}} \times ( {V}_{R} - {V}_{1 [ n ]} ) + Δ V 1 \\ = {V}_{RST} + \frac{{C}_{3}}{{C}_{1} + {C}_{3}} \times ( {V}_{R} - {V}_{1 [ n ]} ) + ( {V}_{S} - {V}_{R} )\end{matrix} \qquad ( 4 )$$

Because V_{R}<V_{1[n]} and V_{S}≦V_{R}, the voltage (Equation (4)) of the first input terminal IN1[n] at the initiation of comparison in the comparison unit 31 according to the second read operation is lower than the voltage V_{RST} of the second input terminal IN2. As illustrated in FIG. 3, the ramp wave, which decreases with the passage of time, is given as the reference signal Ramp, so that the output of the comparison unit 31 can be reliably inverted during the comparison operation and the comparison operation by the comparison unit 31 can be ensured.

After time T4, the ramp waves are given to the second input terminal IN2 as the reference signal Ramp. At the timing at which the voltage of the second input terminal IN2 to which the ramp waves have been given is substantially consistent with the voltage of the first input terminal IN1[n], the comparison output of the comparison unit 31 is inverted. At a time (time T5) at which a predetermined period has elapsed after the input of the ramp waves to the second input terminal IN2 has been initiated, the reference signal generation unit 16 stops the ramp wave generation. Because the measurement unit 32 performs measurement in the count-down mode during the first read operation and the measurement unit 32 performs measurement in the count-up mode during the second read operation, a measurement value related to the third term of the right side of Equation (4) is obtained as a measurement value of the measurement unit 32. Because a coefficient of the third term of the right side is 1 in Equation (4), an AD conversion operation is possible without a decrease in a gain due to the installation of the capacitive element C3.

As described above, the voltage values V_{1[}1], V_{1[}2], and V_{1[}3] are different from each other. In addition, usually, the reset levels output from the unit pixels 3 of each column are substantially the same and signal levels are different. Thus, usually, voltages V_{IN1[}1], V_{IN1[}2], and V_{IN1[}3] (Equation (4)) of the first input terminals IN1[1], IN1[2], and IN1[3] at the initiation of comparison in the comparison unit 31 according to the second read operation are different from each other. Thereby, even when the timings of the comparison starts in the comparison units 31 according to the second read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

As described above, according to the first preferred embodiment, the change unit 18a (the capacitive element C3 and the switch element SW1) changes the voltage of the first input terminal IN1 to a lower voltage so that a voltage difference between the first input terminal IN1 and the second input terminal IN2 becomes a voltage that ensures the comparison operation by the comparison unit 31 after the reset operation by the transistors P6 and P7. Thereby, the comparison unit 31 can reliably perform the comparison operation between the reference signal Ramp and the pixel signal Pixel.

In addition, because a different offset is applied to the first input terminal IN1 of the comparison unit 31 for each of the areas 39a, 39b, and 39c, it is possible to cause the comparison units 31 to end comparisons at different timings even when the comparison units 31 in the column AD conversion units 30 of each of the areas 39a, 39b, and 39c have substantially simultaneously started comparisons. Thereby, it is possible to perform AD conversion with higher precision because power concentration is reduced.

In addition, the change unit 18a is configured so that the other end of the capacitive element C3 is connected to the voltage source V1[n] and the vertical signal line 13 through which the analog signal from the unit pixel 3 is supplied via the switch element SW1, so that an AD conversion operation is possible without reducing gain due to the installation of the capacitive element C3.

### Second Preferred Embodiment

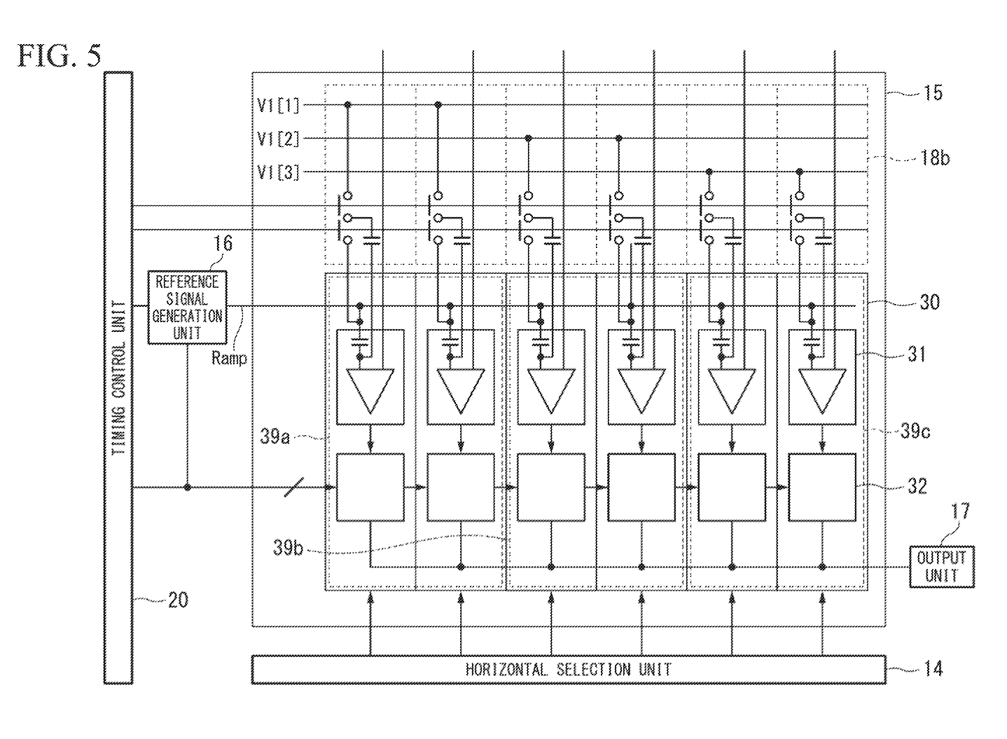

Next, the second preferred embodiment of the present invention will be described. In the second preferred embodiment, the change unit is different from that of the first preferred embodiment. FIG. 5 illustrates an example of a configuration of a column processing unit 15 including a column AD conversion unit 30 and a change unit 18b. Because other components are substantially the same as those illustrated in FIG. 1, a description thereof is omitted here.

The change unit 18b includes a capacitive element and a switch element. One end of the capacitive element is connected to a second input terminal of the comparison unit 31, and the other end of the capacitive element is connected to a voltage source V1[n] (n: 1 to 3) (first voltage source) and a reference signal line through which a reference signal Ramp (second voltage source) from the reference signal generation unit 16 is supplied via the switch element. The voltage source V1[1] supplies a power supply voltage (voltage value: V_{1[n]}) to the change unit 18b corresponding to the column AD conversion unit 30 of the area 39a. The voltage source V1[2] supplies a power supply voltage (voltage value: V_{1[}2]) to the change unit 18b corresponding to the column AD conversion unit 30 of the area 39b. The voltage source V1[3] supplies a power supply voltage (voltage value: V_{1[}3]) to the change unit 18b corresponding to the column AD conversion unit 30 of the area 39c. The relationship of the voltage values V1_{1[n]} (n: 1 to 3), for example, is V_{1[}1]<V_{1[}2]<V_{1[}3]. Furthermore, these are exemplary examples and the present invention is not limited thereto.

Hereinafter, parts different from the first preferred embodiment among operations of this example will be mainly described. As in the first preferred embodiment, a reset level and a signal level are output by the unit pixels 3.

### (First Read)

Once the first read operation from the unit pixel 3 of an arbitrary pixel row to the vertical signal line 13 is stable, a reset operation of the comparison unit 31 is performed. Subsequently, the change unit 18b changes the voltage of the second input terminal of the comparison unit 31 to which the reference signal Ramp has been given to a predetermined voltage higher than the reset level. Thereafter, the timing control unit 20 supplies control data of ramp wave generation to the reference signal generation unit 16. Upon receipt of the control data, the reference signal generation unit 16 outputs the reference signal Ramp of which the waveform varies with time in an overall ramp shape as a comparison voltage given to the second input terminal of the comparison unit 31. The comparison unit 31 compares the voltage of the second input terminal to which the reference signal Ramp has been given from the reference signal generation unit 16 to the voltage of the first input terminal to which the reset level has been given, and inverts a comparison output when the two voltages are substantially the same.

The measurement unit 32 starts measurement in the count-down mode based on the comparison start by the comparison unit 31, and retains a measurement value at a point in time at which the comparison output of the comparison unit 31 has been inverted. That is, the measurement unit 32 retains digital data corresponding to the reset level. The timing control unit 20 stops a supply of control data to the reference signal generation unit 16 and an output of a reference clock when a predetermined period has elapsed. Thereby, the reference signal generation unit 16 stops generation of the reference signal Ramp.

### (Second Read)

Subsequently, during the second read operation, a signal level corresponding to an amount of incident light of each unit pixel 3 is read. During the second read operation, the reset operation of the comparison unit 31 and the change operation by the change unit 18b are not performed.

Once the second read operation from the unit pixel 3 of the arbitrary pixel row to the vertical signal line 13 is stable, the timing control unit 20 supplies control data of ramp wave generation to the reference signal generation unit 16. Upon receipt of the control data, the reference signal generation unit 16 outputs a reference signal Ramp. The comparison unit 31 compares the voltage of the second input terminal to which the reference signal Ramp has been given from the reference signal generation unit 16 to the voltage of the first input terminal to which the signal level has been given, and inverts a comparison output when the two voltages are substantially the same.

The measurement unit 32 starts measurement in the count-up mode based on the comparison start by the comparison unit 31, and retains a measurement value at a point in time at which the comparison output of the comparison unit 31 has been inverted. That is, the measurement unit 32 retains digital data corresponding to a signal component obtained by subtracting the reset level from the signal level. The timing control unit 20 stops supply of control data to the reference signal generation unit 16 and an output of the reference clock when a predetermined period has elapsed. Thereby, the reference signal generation unit 16 stops generation of the reference signal Ramp.

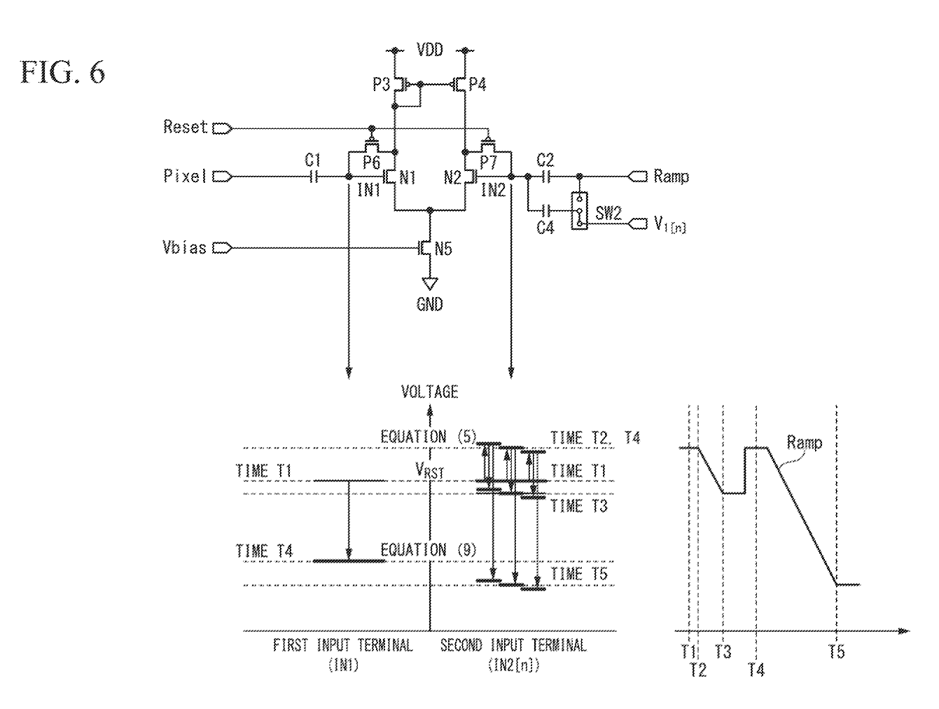

Next, details of configurations of the comparison unit 31 and the change unit 18b and voltage variations in the input terminals of the comparison unit 31 will be described. FIG. 6 illustrates an example of specific circuit configurations of the comparison unit 31 and the change unit 18b. Hereinafter, the circuit configurations of this example will be described. Only components different from those illustrated in FIG. 5 will be described.

The change unit 18b includes a capacitive element C4 (a second capacitive element) and a switch element SW2. One end of the capacitive element C4 is connected to a gate of a transistor N2, and the other end of the capacitive element C4 is connected to a first terminal of the switch element SW2. A second terminal of the switch element SW2 is connected to the voltage source V1[n] (n: 1 to 3), and a third terminal of the switch element SW2 is connected to the other end of the capacitive element C2. The switch element SW2 performs switching between a state in which the voltage source V1[n] is connected to the other end of the capacitive element C4 by short-circuiting the first terminal and the second terminal and a state in which the other end of the capacitive element C2 is connected to the other end of the capacitive element C4 by short-circuiting the first terminal and the third terminal.

Hereinafter, an operation of this example will be described. Here, a voltage of the voltage source V1[n] is represented by V_{1[n]}, a reset-level voltage is represented by V_{R}, a signal-level voltage is represented by V_{S} (V_{S}≦V_{R}), a capacitance value of the capacitive element C2 is represented by C₂, and a capacitance value of the capacitive element C4 is represented by C₄. In addition, a second input terminal IN2 of the differential amplifier connected to the voltage source V1[n] via the capacitive element C4 and the switch element SW2 is represented by a second input terminal IN2[n] (n: 1 to 3). In FIG. 6, voltage variations of the first input terminal N1 and the second input terminal IN2[n] of the differential amplifier within the comparison unit 31 and a waveform of the reference signal Ramp are illustrated.

Once the reset level serving as the pixel signal Pixel from the unit pixel 3 is given to the first input terminal IN1 and the reference signal Ramp given from the reference signal generation unit 16 to the second input terminal IN2 is stable, the timing control unit 20 activates a reset pulse Reset (low active) before the comparison start of the comparison unit 31. Thereby, the transistors P6 and P7 are in the ON state, the gates and the drains of the transistors N1 and N2 are short-circuited, and the voltages of the two input terminals are reset by designating operation points of the transistors N1 and N2 as drain voltages. During the reset operation, the other end of the capacitive element C4 is connected to the voltage source V1[n] through the switch element SW2.

At the operation points determined by the reset operation, offset components of the voltages of the two input terminals of the differential amplifier, that is, the gate voltages of the transistors N1 and N2, are almost canceled. That is, the voltages of the two input terminals of the differential amplifier are reset to be substantially the same voltage V_{RST}. At this time (time T1), the voltage of the first input terminal IN1 is V_{RST} and the voltage of the second input terminal IN2[n] is V_{RST}. After the reset operation, the transistors P6 and P7 are in the OFF state.

Subsequently, the switch element SW2 connects the other end of the capacitive element C4 to the other end of the capacitive element C2, so that the voltage of the second input terminal IN2[n] to which the reference signal Ramp is given, that is, the gate voltage of the transistor N2, is increased and changed from the voltage V_{RST} to a predetermined voltage. Because the voltage of the other end of the capacitive element C4 is varied from V_{1[n]} to V_{Ramp}(0) by (V_{Ramp}(0)−V_{1[n]}) when the voltage of a reference signal Ramp is represented by V_{Ramp}(0) at this time (time T2), the voltage V_{1[n]} of the second input terminal IN2[n] is represented by the following Equation (5). Here, the relationship between the voltage V_{1[n]} of the voltage source V1[n] and the voltage V_{Ramp}(0) of the reference signal Ramp is V_{1[n]}<V_{Ramp}(0).

$${V}_{IN 2 [ n ]} = {V}_{RST} + \frac{{C}_{4}}{{C}_{2} + {C}_{4}} \times ( {V}_{Ramp} ( 0 ) - {V}_{1 [ n ]} ) \qquad ( 5 )$$

Because V_{1[n]}<V_{Ramp}(0) even when some variation remains in the voltages of the two input terminals of the differential amplifier constituting the comparison unit 31 after the reset operation of the comparison unit 31, the voltage (Equation (5)) of the second input terminal IN2[n] at the initiation of comparison in the comparison unit 31 according to the first read operation is higher than the voltage V_{RST} of the first input terminal IN1. As illustrated in FIG. 6, the ramp wave, which decreases with the passage of time, is given as the reference signal Ramp, so that the output of the comparison unit 31 can be reliably inverted during the comparison operation and the comparison operation by the comparison unit 31 can be ensured.

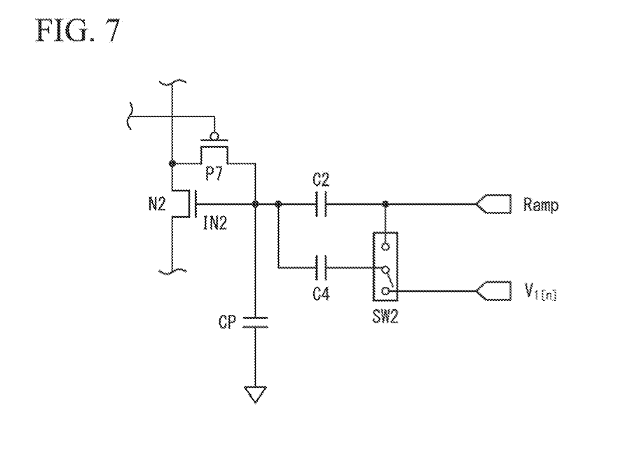

After time T2, the ramp waves are given as the reference signal Ramp to the second input terminal IN2[n]. Hereinafter, the voltage of the second input terminal IN2[n] to which the ramp waves have been given will be described using FIG. 7. FIG. 7 illustrates only an extracted peripheral configuration of the second input terminal IN2[n]. Hereinafter, a parasitic capacitor CP between the second input terminal IN2[n] and the ground GND will be assumed and described.

If voltage variation of the other end of the capacitive element C2 is represented by ΔV3 when a voltage of the ramp waves given to the other end of the capacitive element C2 has been changed from V_{Ramp}(0) to V_{Ramp}(t) by (V_{Ramp}(0−V_{Ramp}(0)), ΔV3 is represented by the following Equation (6).

ΔV3=V_{Ramp}(t)−V_{Ramp}(0) (6)

Because the transistor P7 is in the OFF state during the period from time T2 to time T4, an amount of charges accumulated in the capacitive elements C2 and C4 and the parasitic capacitor CP is retained. Thus, if voltage variation of the second input terminal IN2[n] is represented by ΔV4 when a voltage of the ramp waves given to the other end of the capacitive element C2 has been changed from V_{Ramp}(0) to V_{Ramp}(t) by (V_{R amp}(t)−V_{Ramp}(0)), ΔV4 is represented by the following Equation (7). Furthermore, the capacitive element C2 and the capacitive element C4 are connected in parallel, and a capacitance value of a sum of the capacitive element C2 and the capacitive element C4 connected in parallel is C_{C} of Equation (7). In Equation (7), C_{P} is a capacitance value of the parasitic capacitor CP.

$$Δ V 4 = \frac{{C}_{C}}{{C}_{C} + {C}_{P}} \times Δ V 3 \qquad ( 7 )$$

When C_{P} is negligible compared to C_{C} (C_{C}>>C_{P}), ΔV4=ΔV3. Because the voltage of the second input terminal IN2[n] at time T2 is represented by Equation (5), the voltage V_{IN2[n]} of the second input terminal IN2[n] after time T2 is represented by the following Equation (8). Because the coefficient of the third term of the right side is 1 in Equation (8), it is possible to maintain a time-variable ratio of the reference signal Ramp (a tilt of the reference signal Ramp) to be equal to a time-variable ratio of the reference signal Ramp in the first preferred embodiment even in the second preferred embodiment in which the capacitive element C4 is provided.

$$\begin{matrix}{V}_{IN 2 [ n ]} = {V}_{RST} + \frac{{C}_{4}}{{C}_{2} + {C}_{4}} \times ( {V}_{Ramp} ( 0 ) - {V}_{1 [ n ]} ) + Δ V 4 \\ = {V}_{RST} + \frac{{C}_{4}}{{C}_{2} + {C}_{4}} \times ( {V}_{Ramp} ( 0 ) - {V}_{1 [ n ]} ) + Δ V 3 \\ = {V}_{RST} + \frac{{C}_{4}}{{C}_{2} + {C}_{4}} \times ( {V}_{Ramp} ( 0 ) - {V}_{1 [ n ]} ) + ( {V}_{Ramp} ( t ) - {V}_{Ramp} ( 0 ) )\end{matrix} \qquad ( 8 )$$

At the timing at which the voltage of the second input terminal IN2[n] to which the ramp waves have been given is substantially consistent with the voltage of the first input terminal N1, the comparison output of the comparison unit 31 is inverted. At a time (time T3) at which a predetermined period has elapsed after the input of the ramp waves to the second input terminal IN2[n] has been initiated, the reference signal generation unit 16 stops the ramp wave generation.

After the reset operation of the comparison unit 31, the voltage related to the second term of the right side of Equation (5) is applied as the offset for the second input terminals IN2[1], IN2[2], and IN2[3]. Because the voltage values V_{1[}1], V_{1[}2], and V_{1[}3] are different from each other and reference signals Ramp applied to the second input terminals IN2[n] of the comparison units 31 of the columns are substantially the same, different offsets are applied to the second input terminals IN2[1], IN2[2], and IN2[3]. Accordingly, voltages V_{IN2[}1], V_{IN2[}2], and V_{N2[}3] (Equation (5)) of the second input terminals IN2[1], IN2[2], and IN2[3] at the initiation of comparison by the comparison unit 31 according to the first read operation are different from each other. Thereby, even when the timings of the comparison starts in the comparison units 31 according to the first read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

Subsequently, the signal level serving as the pixel signal Pixel from the unit pixel 3 is given to the first input terminal IN1. At a time (time T2) when the other end of the capacitive element C4 is connected to the other end of the capacitive element C2 by the switch element SW2, the voltage of the other end of the capacitive element C1 to which the reset level is given as the pixel signal Pixel is V_{R}. In addition, at a time (time T4) when the signal level has been input as the pixel signal Pixel, the voltage of the other end of the capacitive element C1 is represented by V_{S}. Accordingly, the voltage V_{IN1} of the first input terminal IN1 at time T4 is represented by the following Equation (9).

V_{IN1}=V_{RST}+(V_{S}−V_{R}) (9)

At time T4 according to the second read operation, the voltage of the second input terminal IN2[n] to which the reference signal Ramp is given is represented by the above-described Equation (5). Because V_{1[n]}<V_{Ramp}(0) in Equation (5) and V_{S}≦V_{R} in Equation (9), the voltage V_{IN2[n]} of Equation (5) is higher than the voltage V_{IN1} of Equation (9). That is, the voltage of the second input terminal IN2[n] at the initiation of comparison in the comparison unit 31 according to the second read operation is higher than the voltage V_{RST} of the first input terminal IN1. As illustrated in FIG. 6, the ramp wave, which decreases with the passage of time, is given as the reference signal Ramp, so that the output of the comparison unit 31 can be reliably inverted during the comparison operation and the comparison operation by the comparison unit 31 can be ensured.

After time T4, the ramp waves are given as the reference signal Ramp to the second input terminal IN2[n]. After a point in time at which the ramp waves have been given to the second input terminal IN2[n], the voltage V_{IN2[n]} of the second input terminal IN2[n] is represented by the above-described Equation (8). At the timing at which the voltage of the second input terminal IN2[n] to which the ramp waves have been given is substantially consistent with the voltage of the first input terminal N1, the comparison output of the comparison unit 31 is inverted. At a time (time T5) at which a predetermined period has elapsed after the input of the ramp waves to the second input terminal IN2[n] has been initiated, the reference signal generation unit 16 stops the ramp wave generation. Because the measurement unit 32 performs measurement in the count-down mode during the first read operation and the measurement unit 32 performs measurement in the count-up mode during the second read operation, a measurement value related to the second term (V_{S}−V_{R}) of the right side of Equation (9) is obtained as a measurement value of the measurement unit 32.

As described above, the voltages V_{IN2[}1], V_{IN2[}2], and V_{IN2[}3] of the second input terminals IN2[1], IN2[2], and IN2[3] at the initiation of comparison in the comparison unit 31 according to the second read operation are represented by Equation (5) and are different from each other. Thereby, even when the timings of the comparison starts in the comparison units 31 according to the second read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

As described above, according to the second preferred embodiment, the change unit 18b (the capacitive element C4 and the switch element SW2) changes the voltage of the second input terminal IN2 to a higher voltage so that a voltage difference between the first input terminal IN1 and the second input terminal IN2 becomes a voltage that ensures the comparison operation by the comparison unit 31 after the reset operation by the transistors P6 and P7. Thereby, the comparison unit 31 can reliably perform the comparison operation between the reference signal Ramp and the pixel signal Pixel.

In addition, because a different offset is applied to the second input terminal IN2 of the comparison unit 31 for each of the areas 39a, 39b, and 39c, it is possible to cause the comparison units 31 to end comparisons at different timings even when the comparison units 31 in the column AD conversion units 30 of each of the areas 39a, 39b, and 39c have substantially simultaneously started comparisons. Thereby, it is possible to perform AD conversion with higher precision because power concentration is reduced.

In addition, the change unit 18b is configured so that the other end of the capacitive element C4 is connected to the voltage source V1[n] and the reference signal line through which the reference signal Ramp from the reference signal generation unit 16 is supplied via the switch element SW2, so that a time-variable ratio of the reference signal Ramp can be maintained to be equal to a time-variable ratio of the reference signal Ramp in the first preferred embodiment.

### Third Preferred Embodiment

Next, the third preferred embodiment of the present invention will be described.

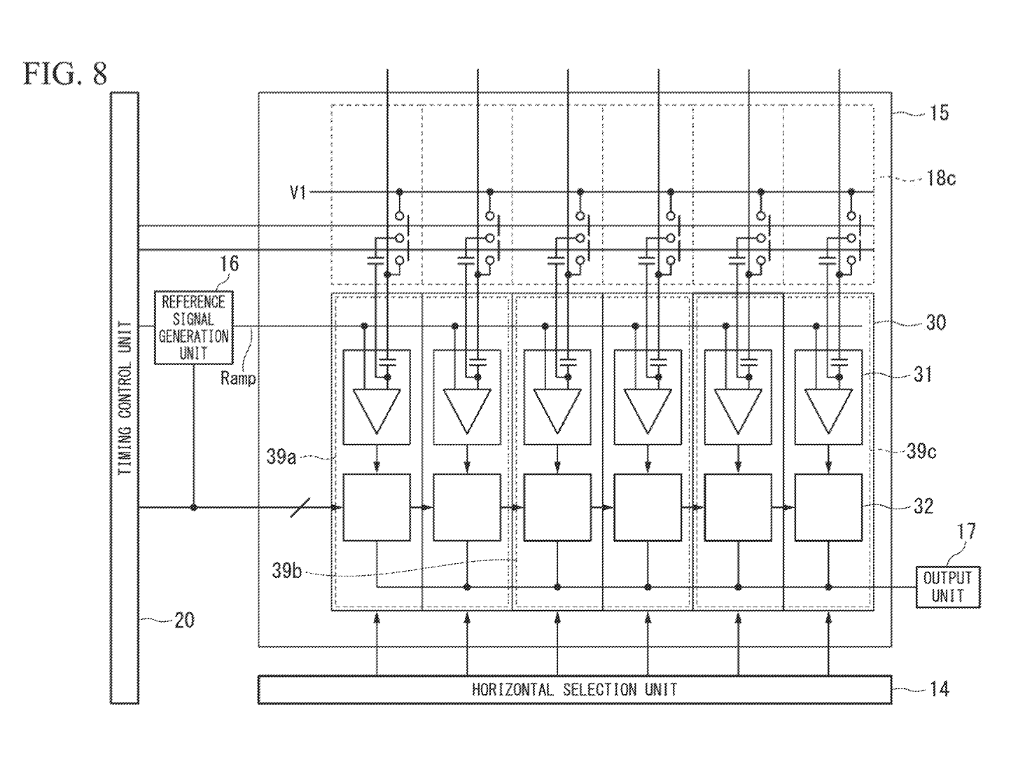

In the third preferred embodiment, the change unit is different from that of the first preferred embodiment. FIG. 8 illustrates an example of a configuration of a column processing unit 15 including a column AD conversion unit 30 and a change unit 18c. Because other components are substantially the same as those illustrated in FIG. 1, a description thereof is omitted here.

The change unit 18c includes a capacitive element and a switch element. One end of the capacitive element is connected to a first input terminal of the comparison unit 31, and the other end of the capacitive element is connected to a voltage source V1 (first voltage source) and the vertical signal line 13 through which an analog signal (second voltage source) from the unit pixel 3 is supplied via the switch element. The voltage source V1 supplies a power supply voltage (voltage value: V₁) to the change unit 18c. A capacitive element provided in the change unit 18c is represented by a capacitive element C3[n] (n: 1 to 3), and its capacitance value is represented by C_{3[n]} (n: 1 to 3). A capacitance value of the capacitive element C3[1] of the change unit 18c corresponding to the column AD conversion unit 30 of the area 39a is C_{3[}1].

A capacitance value of the capacitive element C3[2] of the change unit 18c corresponding to the column AD conversion unit 30 of the area 39b is C_{3[}2]. A capacitance value of the capacitive element C3[3] of the change unit 18c corresponding to the column AD conversion unit 30 of the area 39c is C_{3[}3]. The relationship of the capacitance values C_{3[n]} (n: 1 to 3), for example, is C_{3[}1]<C_{3[}2]<C_{3[}3]. Furthermore, these are exemplary examples and the present invention is not limited thereto.

Because operations of the column AD conversion unit 30 and the change unit 18c during the first and second read operations are substantially the same as those of the column AD conversion unit 30 and the change unit 18a in the first preferred embodiment, a description thereof is omitted here.

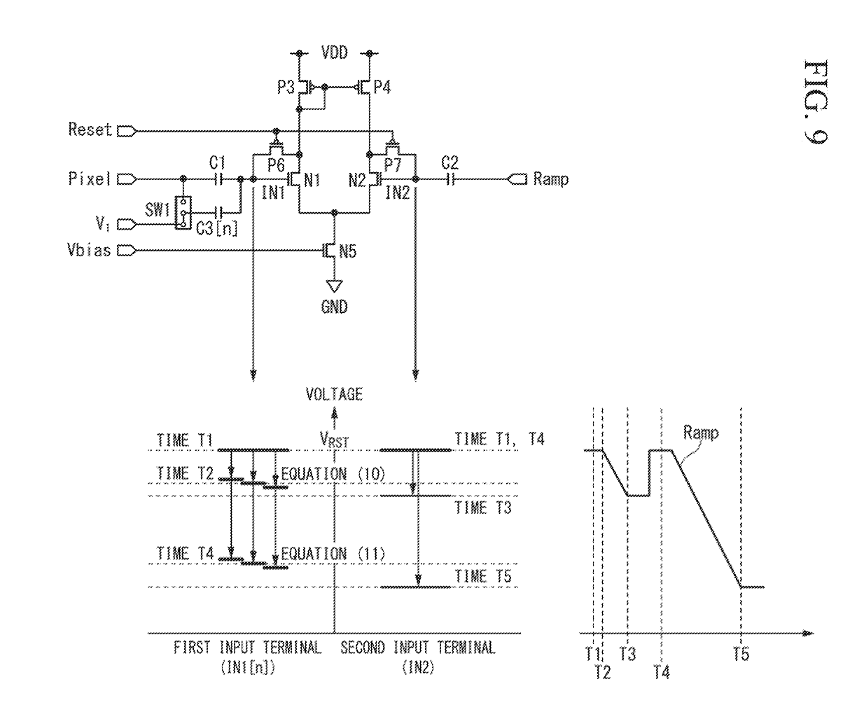

Next, details of configurations of the comparison unit 31 and the change unit 18c and voltage variations in the input terminals of the comparison unit 31 will be described. FIG. 9 illustrates an example of specific circuit configurations of the comparison unit 31 and the change unit 18c. Hereinafter, only parts different from those of the first preferred embodiment in the circuit configurations of this example will be described.

The change unit 18c includes a capacitive element C3[n] (a second capacitive element) and a switch element SW1. One end of the capacitive element C3[n] is connected to the gate of the transistor N1, and the other end of the capacitive element C3[n] is connected to a first terminal of the switch element SW1. A second terminal of the switch element SW1 is connected to the voltage source V1, and a third terminal of the switch element SW1 is connected to the other end of the capacitive element C1. According to a control signal (not illustrated) from the timing control unit 20, the switch element SW1 performs switching between a state in which the voltage source V1 is connected to the other end of the capacitive element C3[n] by short-circuiting the first terminal and the second terminal and a state in which the other end of the capacitive element C1 is connected to the other end of the capacitive element C3[n] by short-circuiting the first terminal and the third terminal.

For example, the capacitive element C3[n] includes a plurality of unit capacitive elements having the same capacitance value, and the capacitance value may be changed by controlling connections thereof. Furthermore, in the configuration illustrated in FIG. 9, it is desirable to configure the capacitive element C1 as a capacitive element C1[n] (n: 1 to 3) having a different capacitance value for each area and uniformly maintain a sum of the capacitance values of the capacitive elements C1[n] and C3[n].

Hereinafter, an operation of this example will be described. Here, a voltage of the voltage source V1 is represented by V₁, a reset-level voltage is represented by V_{R} (here, V_{R}<V₁), a signal-level voltage is represented by V_{S} (V_{S}≦V_{R}), a capacitance value of the capacitive element C1 is represented by C₁, and a capacitance value of the capacitive element C3[n] is represented by C_{3[n]}. In addition, a first input terminal IN1 of the differential amplifier connected to the voltage source V1 via the capacitive element C3[n] and the switch element SW1 is represented by a first input terminal IN1[n] (n: 1 to 3). In FIG. 9, voltage variations of the first input terminal IN1[n] and the second input terminal IN2 of the differential amplifier within the comparison unit 31 and a waveform of the reference signal Ramp are illustrated.

Once the reset level serving as the pixel signal Pixel from the unit pixel 3 is given to the first input terminal IN1[n] and the reference signal Ramp given from the reference signal generation unit 16 to the second input terminal IN2 is stable, the timing control unit 20 activates a reset pulse Reset (low active) before the comparison start of the comparison unit 31. Thereby, the transistors P6 and P7 are in the ON state, the gates and the drains of the transistors N1 and N2 are short-circuited, and the voltages of the two input terminals are reset by designating operation points of the transistors N1 and N2 as drain voltages. During the reset operation, the other end of the capacitive element C3[n] is connected to the voltage source V1 through the switch element SW1.

At the operation points determined by the reset operation, offset components of the voltages of the two input terminals of the differential amplifier, that is, the gate voltages of the transistors N1 and N2, are almost canceled. That is, the voltages of the two input terminals of the differential amplifier are reset to be substantially the same voltage V_{RST}. At this time (time T1), the voltage of the first input terminal IN1[n] is V_{RST} and the voltage of the second input terminal IN2 is V_{RST}. After the reset operation, the transistors P6 and P7 are in the OFF state.

Subsequently, the switch element SW1 connects the other end of the capacitive element C3[n] to the other end of the capacitive element C1, so that the voltage of the first input terminal IN1[n] to which the pixel signal Pixel is given, that is, the gate voltage of the transistor N1, is reduced and changed from the voltage V_{RST} to a predetermined voltage. At this time (time T2), the voltage V_{IN1[}n] of the first input terminal IN1[n] is represented by the following Equation (10) as in Equation (1) in the first preferred embodiment.

$${V}_{IN 1 [ n ]} = {V}_{RST} + \frac{{C}_{3 [ n ]}}{{C}_{1} + {C}_{3 [ n ]}} \times ( {V}_{R} - {V}_{1} ) \qquad ( 10 )$$

Because V_{R}<V₁ even when some variation remains in the voltages of the two input terminals of the differential amplifier constituting the comparison unit 31 after the reset operation of the comparison unit 31, the voltage (Equation (10)) of the first input terminal IN1[n] at the initiation of comparison in the comparison unit 31 according to the first read operation is lower than the voltage V_{RST} of the second input terminal IN2. As illustrated in FIG. 9, the ramp wave, which decreases with the passage of time, is given as the reference signal Ramp, so that the output of the comparison unit 31 can be reliably inverted during the comparison operation and the comparison operation by the comparison unit 31 can be ensured.

After time T2, the ramp waves are given as the reference signal Ramp to the second input terminal IN2. At the timing at which the voltage of the second input terminal IN2 to which the ramp waves have been given is substantially consistent with the voltage of the first input terminal IN1[n], the comparison output of the comparison unit 31 is inverted. At a time (time T3) at which a predetermined period has elapsed after the input of the ramp waves to the second input terminal IN2 has been initiated, the reference signal generation unit 16 stops the ramp wave generation.

After the reset operation of the comparison unit 31, the voltage related to the second term of the right side of Equation (10) is applied as the offset for the first input terminals IN1[1], IN1[2], and IN1[3]. Because the capacitance values C_{3[}1], C_{3[}2], and C_{3[}3] are different from each other and reset levels output from the unit pixels 3 of the columns are substantially the same, different offsets are applied to the first input terminals IN1[1], IN1[2], and IN1[3].

Accordingly, voltages V_{IN1[}1], V_{IN1[}2], and V_{IN1[}3] (Equation (10)) of the first input terminals IN1[1], IN1[2], and IN1[3] at the initiation of comparison in the comparison unit 31 according to the first read operation are different from each other. Thereby, even when the timings of the comparison starts in the comparison units 31 according to the first read operation are substantially the same, the timing of the comparison end is different in the comparison unit 31 of the column AD conversion unit 30 of each of the areas 39a, 39b, and 39c.

As described above, the comparison unit 31 ends the comparison operation at a different timing for each of the areas 39a, 39b, and 39c, so that it is possible to perform AD conversion with higher precision because power concentration is reduced.

Subsequently, the signal level serving as the pixel signal Pixel from the unit pixel 3 is given to the first input terminal IN1[n]. The voltage V_{IN1[}1] of the first input terminal IN1[n] at this time (time T4) is represented by the following Equation (11) as in Equation (4) of the first preferred embodiment.

$${V}_{IN 1 [ n ]} = {V}_{RST} + \frac{{C}_{3 [ n ]}}{{C}_{1} + {C}_{3 [ n ]}} \times ( {V}_{R} - {V}_{1} ) + ( {V}_{S} - {V}_{R} ) \qquad ( 11 )$$

Because V_{R}<V₁ and V_{S}≦V_{R} as described above, the voltage (Equation (11)) of the first input terminal IN1[n] at the initiation of comparison in the comparison unit 31 according to the second read operation is lower than the voltage V_{RST} of the second input terminal IN2. As illustrated in FIG. 9, the ramp wave, which decreases with the passage of time, is given as the reference signal Ramp, so that the output of the comparison unit 31 can be reliably inverted during the comparison operation and the comparison operation by the comparison unit 31 can be ensured.

After time T4, the ramp waves are given as the reference signal Ramp to the second input terminal IN2. At the timing at which the voltage of the second input terminal IN2 to which the ramp waves have been given is substantially consistent with the voltage of the first input terminal IN1[n], the comparison output of the comparison unit 31 is inverted. At a time (time T5) at which a predetermined period has elapsed after the input of the ramp waves to the second input terminal IN2 has been initiated, the reference signal generation unit 16 stops ramp wave generation. Because the measurement unit 32 performs measurement in the count-down mode during the first read operation and the measurement unit 32 performs measurement in the count-up mode during the second read operation, a measurement value related to the third term of the right side of Equation (11) is obtained as a measurement value of the measurement unit 32. An AD conversion operation is possible without a decrease in gain due to the installation of the capacitive element.

The capacitance values C_{3[}1], C_{3[}2], and C_{3[}3] are different from each other. In addition, usually, the reset levels output from the unit pixels 3 of each column are substantially the same and signal levels are different. Thus, usually, voltages V_{IN1[}1], V_{IN1[}2], and V_{IN1[}3] (Equation (11)) of the first input terminals IN1[1], IN1[2], and IN1[3] at the initiation of comparison in the comparison unit 31 according to the second read operation are different from each other. Thereby, even when the timings of the comparison starts in the comparison units 31 according to the second read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

As described above, according to the third preferred embodiment, the change unit 18c (the capacitive element C3[n] and the switch element SW1) changes the voltage of the first input terminal IN1 to a lower voltage so that a voltage difference between the first input terminal IN1 and the second input terminal IN2 becomes a voltage that ensures the comparison operation by the comparison unit 31 after the reset operation by the transistors P6 and P7. Thereby, the comparison unit 31 can reliably perform the comparison operation between the reference signal Ramp and the pixel signal Pixel.

In addition, because a different offset is applied to the first input terminal IN1 of the comparison unit 31 for each of the areas 39a, 39b, and 39c, it is possible to cause the comparison units 31 to end comparisons at different timings even when the comparison units 31 in the column AD conversion units 30 of each of the areas 39a, 39b, and 39c have substantially simultaneously started comparisons. Thereby, it is possible to perform AD conversion with higher precision because power concentration is reduced.

In addition, it is possible to easily configure the change unit 18c by configuring the change unit 18c so that the capacitance value of the capacitive element C3[n] of the change unit 18c differs according to each of the areas 39a, 39b, and 39c.

### Fourth Preferred Embodiment

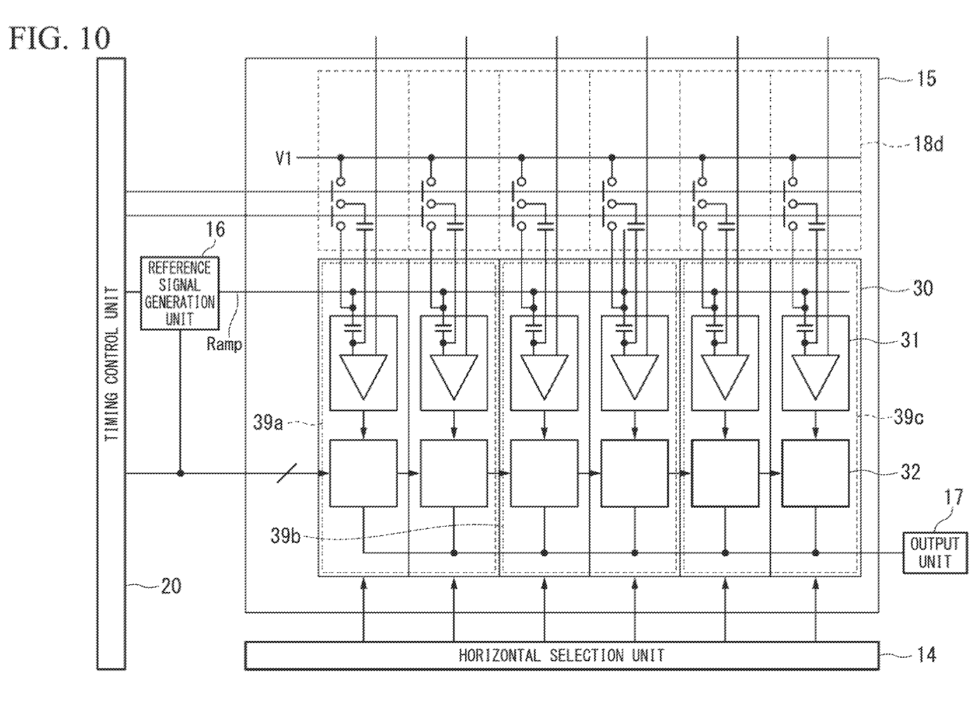

Next, the fourth preferred embodiment of the present invention will be described. In the fourth preferred embodiment, the change unit is different from that of the second preferred embodiment. FIG. 10 illustrates an example of a configuration of a column processing unit 15 including a column AD conversion unit 30 and a change unit 18d. Because other components are substantially the same as those illustrated in FIG. 1, a description thereof is omitted here.

The change unit 18d includes a capacitive element and a switch element. One end of the capacitive element is connected to a second input terminal of the comparison unit 31, and the other end of the capacitive element is connected to a voltage source V1 (first voltage source) and the reference signal line through which a reference signal Ramp (second voltage source) from the reference signal generation unit 16 is supplied via the switch element. The voltage source V1 supplies a power supply voltage (voltage value: V₁) to the change unit 18d.

A capacitive element provided in the change unit 18d is represented by a capacitive element C4[n] (n: 1 to 3), and its capacitance value is represented by C_{4[n]} (n: 1 to 3). A capacitance value of the capacitive element C4[1] of the change unit 18d corresponding to the column AD conversion unit 30 of the area 39a is C_{4[}1]. A capacitance value of the capacitive element C4[2] of the change unit 18d corresponding to the column AD conversion unit 30 of the area 39b is C_{4[}2]. A capacitance value of the capacitive element C4[3] of the change unit 18d corresponding to the column AD conversion unit 30 of the area 39a is C_{4[}3]. The relationship of the capacitance values C_{4[n]} (n: 1 to 3), for example, is C_{4[}1]>C_{4[}2]>C_{4[}3]. Furthermore, these are exemplary examples and the present invention is not limited thereto.

Because operations of the column AD conversion unit 30 and the change unit 18d during the first and second read operations are substantially the same as those of the column AD conversion unit 30 and the change unit 18a in the first preferred embodiment, a description thereof is omitted here.

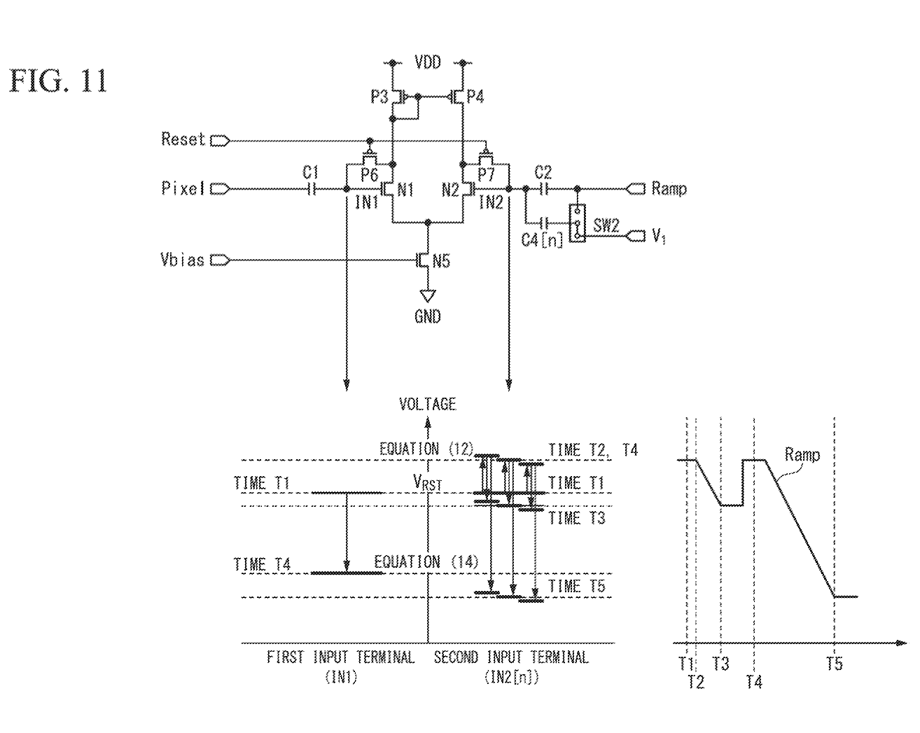

Next, details of configurations of the comparison unit 31 and the change unit 18d and voltage variations in the input terminals of the comparison unit 31 will be described. FIG. 11 illustrates an example of specific circuit configurations of the comparison unit 31 and the change unit 18d.

Hereinafter, only parts different from those of the first preferred embodiment in the circuit configurations of this example will be described.

The change unit 18d includes a capacitive element C4[n] (second capacitive element) and a switch element SW2. One end of the capacitive element C4[n] is connected to the gate of the transistor N2, and the other end of the capacitive element C4[n] is connected to a first terminal of the switch element SW2. A second terminal of the switch element SW2 is connected to the voltage source V1, and a third terminal of the switch element SW2 is connected to the other end of the capacitive element C2. The switch element SW2 performs switching between a state in which the voltage source V1 is connected to the other end of the capacitive element C4[n] by short-circuiting the first terminal and the second terminal and a state in which the other end of the capacitive element C2 is connected to the other end of the capacitive element C4[n] by short-circuiting the first terminal and the third terminal.

For example, the capacitive element C4[n] includes a plurality of unit capacitive elements having the same capacitance value, and the capacitance value may be changed by controlling connections thereof. Furthermore, in the configuration illustrated in FIG. 11, it is desirable to configure the capacitive element C2 as a capacitive element C2[n] (n: 1 to 3) having a different capacitance value for each area and uniformly maintain a sum of the capacitance values of the capacitive elements C2[n] and C4[n].

Hereinafter, an operation of this example will be described. Here, the voltage of the voltage source V1 is represented by V₁, the reset-level voltage is represented by V_{R}, the signal-level voltage is represented by V_{S} (V_{S}≦V_{R}), the capacitance value of the capacitive element C2 is represented by C₂, and the capacitance value of the capacitive element C4[n] is represented by C_{4[n]}. In addition, a second input terminal IN2 of the differential amplifier connected to the voltage source V1 via the capacitive element C4[n] and the switch element SW2 is represented by a second input terminal IN2[n] (n: 1 to 3). In FIG. 11, voltage variations of the first input terminal IN1 and the second input terminal 1N2[n] of the differential amplifier within the comparison unit 31 and a waveform of the reference signal Ramp are illustrated.

Once the reset level serving as the pixel signal Pixel from the unit pixel 3 is given to the first input terminal IN1 and the reference signal Ramp given from the reference signal generation unit 16 to the second input terminal IN2[n] is stable, the timing control unit 20 activates a reset pulse Reset (low active) before the comparison start of the comparison unit 31. Thereby, the transistors P6 and P7 are in the ON state, the gates and the drains of the transistors N1 and N2 are short-circuited, and the voltages of the two input terminals are reset by designating operation points of the transistors N1 and N2 as drain voltages. During the reset operation, the other end of the capacitive element C4[n] is connected to the voltage source V1 through the switch element SW2.

At the operation points determined by the reset operation, offset components of the voltages of the two input terminals of the differential amplifier, that is, the gate voltages of the transistors N1 and N2, are almost canceled. That is, the voltages of the two input terminals of the differential amplifier are reset to be substantially the same voltage V_{RST}. At this time (time T1), the voltage of the first input terminal IN1 is V_{RST} and the voltage of the second input terminal IN2[n] is V_{RST}. After the reset operation, the transistors P6 and P7 are in the OFF state.

Subsequently, the switch element SW2 connects the other end of the capacitive element C4[n] to the other end of the capacitive element C2, so that the voltage of the second input terminal IN2[n] to which the reference signal Ramp is given, that is, the gate voltage of the transistor N2, is increased and changed from the voltage V_{RST} to a predetermined voltage. At this time (time T2), the voltage V_{N2[}n] of the second input terminal IN2[n] is represented by the following Equation (12) as in Equation (5) in the second preferred embodiment.

$${V}_{IN 2 [ n ]} = {V}_{RST} + \frac{{C}_{4 [ n ]}}{{C}_{2} + {C}_{4 [ n ]}} \times ( {V}_{Ramp} ( 0 ) - {V}_{1} ) \qquad ( 12 )$$

Because V₁<V_{Ramp}(0) even when some variation remains in the voltages of the two input terminals of the differential amplifier constituting the comparison unit 31 after the reset operation of the comparison unit 31, the voltage (Equation (12)) of the second input terminal IN2[n] at the initiation of comparison in the comparison unit 31 according to the first read operation is higher than the voltage V_{RST} of the first input terminal IN1. As illustrated in FIG. 11, the ramp wave, which decreases with the passage of time, is given as the reference signal Ramp, so that the output of the comparison unit 31 can be reliably inverted during the comparison operation and the comparison operation by the comparison unit 31 can be ensured.

After time T2, the ramp waves are given as the reference signal Ramp to the second input terminal IN2[n]. When the voltage of the ramp waves given to the other end of the capacitive element C2 has been changed from V_{Ramp}(0) to V_{Ramp}(t) by (V_{Ramp}(t)−V_{Ramp}(0)), the voltage V_{IN2[n]} of the second input terminal IN2[n] is represented by the following Equation (13) as in Equation (8) in the second preferred embodiment. Because the coefficient of the third term of the right side in Equation (13) is 1, it is possible for a time-variable ratio of the reference signal Ramp (a tilt of the reference signal Ramp) to be maintained equal to a time-variable ratio of the reference signal Ramp in the first preferred embodiment even in the fourth preferred embodiment in which the capacitive element C4[n] is provided.

$${V}_{IN 2 [ n ]} = {V}_{RST} + \frac{{C}_{4 [ n ]}}{{C}_{2} + {C}_{4 [ n ]}} \times ( {V}_{Ramp} ( 0 ) - {V}_{1} ) + ( {V}_{Ramp} ( t ) - {V}_{Ramp} ( 0 ) ) \qquad ( 13 )$$

At the timing at which the voltage of the second input terminal IN2[n] to which the ramp waves have been given is substantially consistent with the voltage of the first input terminal N1, the comparison output of the comparison unit 31 is inverted. At a time (time T3) at which a predetermined period has elapsed after the input of the ramp waves to the second input terminal IN2[n] has been initiated, the reference signal generation unit 16 stops the ramp wave generation.

After the reset operation of the comparison unit 31, the voltage related to the second term of the right side of Equation (12) is applied as the offset for the second input terminals IN2[1], IN2[2], and IN2[3]. Because the capacitance values C_{4[}1], C_{4[}2], and C_{4[}3] are different from each other and reference signals Ramp applied to the second input terminals IN2[n] of the comparison units 31 of the columns are substantially the same, different offsets are applied to the second input terminals IN2[1], IN2[2], and IN2[3]. Accordingly, voltages V_{IN2[}1], V_{IN2[}2], and V_{IN2[}3] (Equation (12)) of the second input terminals IN1[1], IN1[2], and IN1[3] at the initiation of comparison in the comparison unit 31 according to the first read operation are different from each other. Thereby, even when the timings of the comparison starts in the comparison units 31 according to the first read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

Subsequently, the signal level serving as the pixel signal Pixel from the unit pixel 3 is given to the first input terminal IN1. The voltage V_{IN1} of the first input terminal IN1 at this time (time T4) is represented by the following Equation (14) as in Equation (9) in the second preferred embodiment.

V_{IN1}=V_{RST}+(V_{S}−V_{R}) (14)

At time T4 according to the second read operation, the voltage of the second input terminal IN2[n] to which the reference signal Ramp is given is represented by the above-described Equation (12). Because V₁<V_{Ramp}(0) in Equation (12) and Vₛ V_{R} in Equation (14), the voltage V_{IN2[n]} of Equation (12) is higher than the voltage V_{IN1} of Equation (14). That is, the voltage of the second input terminal IN2[n] at the initiation of comparison in the comparison unit 31 according to the second read operation is higher than the voltage of the first input terminal IN1. As illustrated in FIG. 11, the ramp wave, which decreases with the passage of time, is given as the reference signal Ramp, so that the output of the comparison unit 31 can be reliably inverted during the comparison operation and the comparison operation by the comparison unit 31 can be ensured.

After time T4, the ramp waves are given as the reference signal Ramp to the second input terminal IN2[n]. After a point in time at which the ramp waves have been given to the second input terminal IN2[n], the voltage V_{IN2[n]} of the second input terminal IN2[n] is represented by the above-described Equation (13). At the timing at which the voltage of the second input terminal IN2[n] to which the ramp waves have been given is substantially consistent with the voltage of the first input terminal N1, the comparison output of the comparison unit 31 is inverted. At a time (time T5) when a predetermined period has elapsed after the input of the ramp waves to the second input terminal IN2 has been initiated, the reference signal generation unit 16 stops the ramp wave generation. Because the measurement unit 32 performs measurement in the count-down mode during the first read operation and the measurement unit 32 performs measurement in the count-up mode during the second read operation, a measurement value related to the second term (V_{S}−V_{R}) of the right side of Equation (14) is obtained as a measurement value of the measurement unit 32.

As described above, voltages V_{IN2[}1], V_{IN2[}2], and V_{IN2[}3] (Equation (12)) of the second input terminals IN2[1], IN2[2], and IN2[3] at the initiation of comparison in the comparison unit 31 according to the second read operation are different from each other. Thereby, even when the timings of the comparison starts in the comparison units 31 according to the second read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

As described above, according to the fourth preferred embodiment, the change unit 18d (the capacitive element C4[n] and the switch element SW2) changes the voltage of the second input terminal IN2 to a higher voltage so that a voltage difference between the first input terminal IN1 and the second input terminal IN2 becomes a voltage that ensures the comparison operation by the comparison unit 31 after the reset operation by the transistors P6 and P7. Thereby, the comparison unit 31 can reliably perform the comparison operation between the reference signal Ramp and the pixel signal Pixel.

In addition, because a different offset is applied to the second input terminal IN2 of the comparison unit 31 for each of the areas 39a, 39b, and 39c, it is possible to cause the comparison units 31 to end comparisons at different timings even when the comparison units 31 in the column AD conversion units 30 of each of the areas 39a, 39b, and 39c have substantially simultaneously started comparisons. Thereby, it is possible to perform AD conversion with higher precision because power concentration is reduced.

In addition, it is possible to easily configure the change unit 18d by configuring the change unit 18d so that the capacitance value of the capacitive element C4[n] of the change unit 18d differs according to each of the areas 39a, 39b, and 39c.

### Fifth Preferred Embodiment

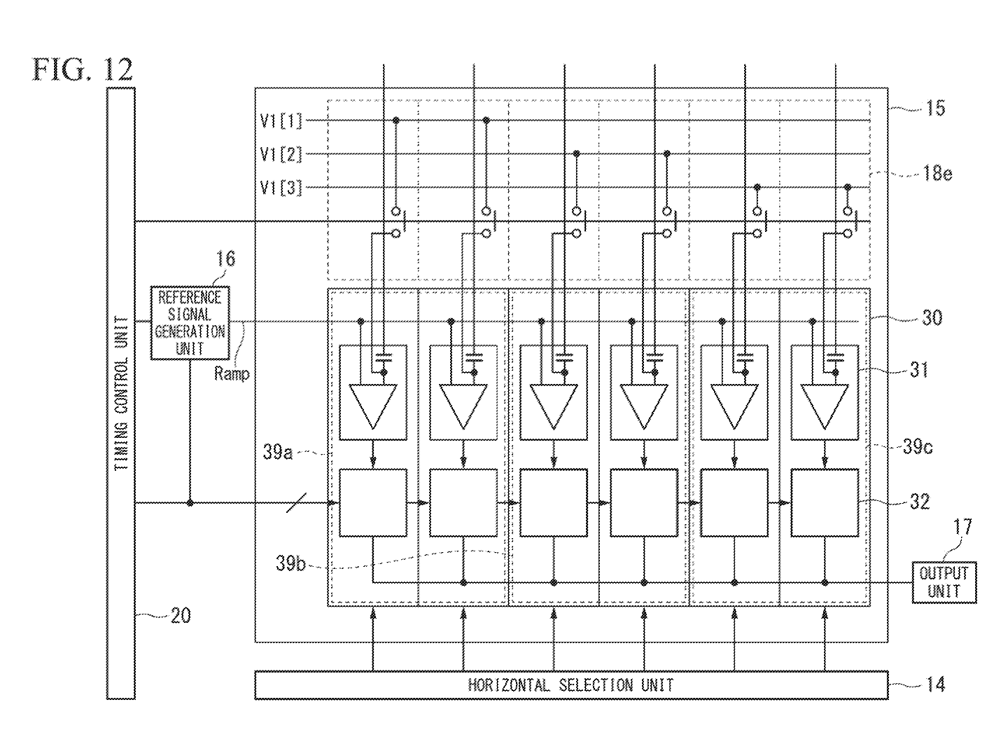

Next, the fifth preferred embodiment of the present invention will be described. In the fifth preferred embodiment, the change unit is different from that of the first preferred embodiment. FIG. 12 illustrates an example of a configuration of a column processing unit 15 including a column AD conversion unit 30 and a change unit 18e. Because other components are substantially the same as those illustrated in FIG. 1, a description thereof is omitted here.

The change unit 18e includes a switch element. One end of the switch element is connected to the first input terminal of the comparison unit 31, and the other end of the switch element is connected to a voltage source V1[n] (n: 1 to 3). The voltage source V1[1] supplies a power supply voltage (voltage value: V_{1[}1]) to the change unit 18e corresponding to the column AD conversion unit 30 of the area 39a. The voltage source V1[2] supplies a power supply voltage (voltage value: V_{1[}2]) to the change unit 18e corresponding to the column AD conversion unit 30 of the area 39b. The voltage source V1[3] supplies a power supply voltage (voltage value: V_{1[}3]) to the change unit 18e corresponding to the column AD conversion unit 30 of the area 39c. The relationship of the voltage values V_{1[n]} (n: 1 to 3), for example, is V_{1[}1]>V_{1[}2]>V_{1[}3]. Furthermore, these are exemplary examples and the present invention is not limited thereto.

Because operations of the column AD conversion unit 30 and the change unit 18e during the first and second read operations are substantially the same as those of the column AD conversion unit 30 and the change unit 18a in the first preferred embodiment, a description thereof is omitted here.

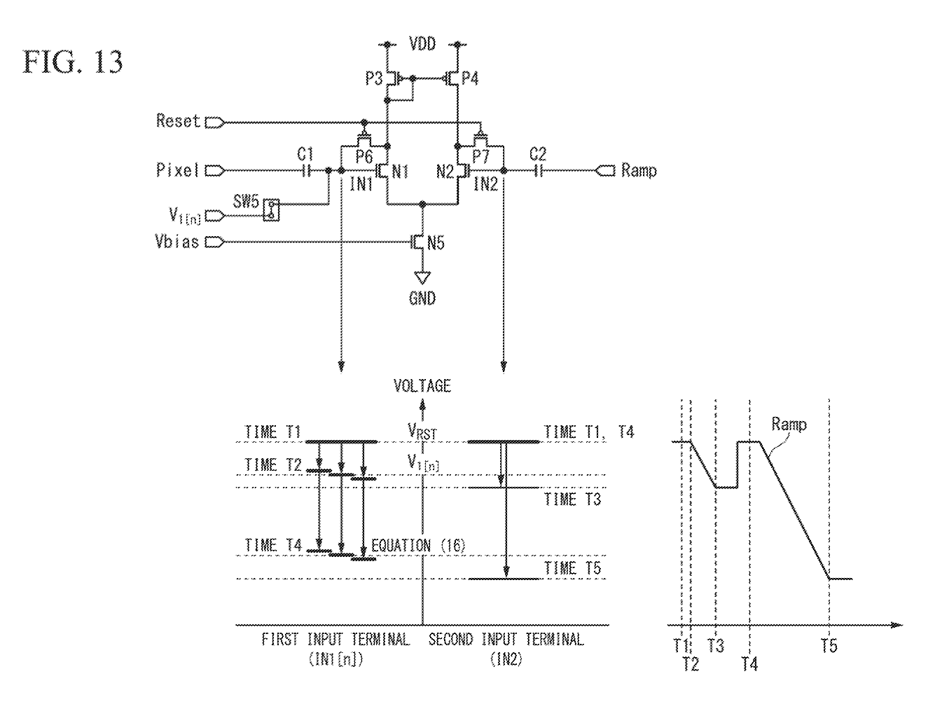

Next, details of configurations of the comparison unit 31 and the change unit 18e and voltage variations in the input terminals of the comparison unit 31 will be described. FIG. 13 illustrates an example of specific circuit configurations of the comparison unit 31 and the change unit 18e. Hereinafter, only parts different from those of the first preferred embodiment in the circuit configurations of this example will be described.

The change unit 18e includes a switch element SW5. One end of the switch element SW5 is connected to the gate of the transistor N1, and the other end of the switch element SW5 is connected to a voltage source V1[n] (n: 1 to 3). According to a control signal (not illustrated) from the timing control unit 20, ON and OFF states of the switch element SW5 are controlled.

Hereinafter, an operation of this example will be described. Herein, a voltage of the voltage source V1[n] is represented by V_{1[n]}, a voltage of the reset level is represented by V_{R}, a voltage of the signal level is represented by V_{S} (here, V_{S}≦V_{R}), and a capacitance value of the capacitive element C1 is represented by C₁. In addition, the first input terminal IN1 of the differential amplifier connected to the voltage source V1[n] via the switch element SW5 is represented by a first input terminal IN[n] (n: 1 to 3). In FIG. 13, voltage variations of the first input terminal IN1[n] and the second input terminal IN2 of the differential amplifier within the comparison unit 31 and a waveform of the reference signal Ramp are illustrated.

Once the reset level serving as the pixel signal Pixel from the unit pixel 3 is given to the first input terminal IN1[n] and the reference signal Ramp given from the reference signal generation unit 16 to the second input terminal IN2 is stable, the timing control unit 20 activates a reset pulse Reset (low active) before the comparison start of the comparison unit 31. Thereby, the transistors P6 and P7 are in the ON state, the gates and the drains of the transistors N1 and N2 are short-circuited, and the voltages of the two input terminals are reset by designating operation points of the transistors N1 and N2 as drain voltages. During the reset operation, the switch element SW5 is in the OFF state and the other end of the switch element SW5 is separated from the voltage source V1[n].

At the operation points determined by the reset operation, offset components of the voltages of the two input terminals of the differential amplifier, that is, the gate voltages of the transistors N1 and N2, are almost canceled. That is, the voltages of the two input terminals of the differential amplifier are reset to be substantially the same voltage V_{RST}. At this time (time T1), the voltage of the first input terminal IN1[n] is V_{RST} and the voltage of the second input terminal IN2 is V_{RST}. After the reset operation, the transistors P6 and P7 are in the OFF state.

Subsequently, the switch element SW5 changes from the OFF state to the ON state, so that the voltage of the first input terminal IN1[n] to which the pixel signal Pixel is given, that is, the gate voltage of the transistor N1, is reduced and changed from the voltage V_{RST} to a predetermined voltage V_{1[n]}. At this time (time T2), the voltage of the first input terminal IN1[n] is V_{1[n]} and the voltage of the second input terminal IN2 is V_{RST}. Here, the relationship between the voltage V_{1[n]} of the voltage source V1[n] and the reset voltage V_{RST} is V_{1[n]}<V_{RST}. The switch element SW5 is in the OFF state after the ON state.

Because V_{1[n]}<V_{RST} even when some variation remains in the voltages of the two input terminals of the differential amplifier constituting the comparison unit 31 after the reset operation of the comparison unit 31, the voltage V_{1[n]} of the first input terminal IN1[n] at the initiation of comparison in the comparison unit 31 according to the first read operation is lower than the voltage V_{RST} of the second input terminal IN2. As illustrated in FIG. 13, the ramp wave, which decreases with the passage of time, is given as the reference signal Ramp, so that the output of the comparison unit 31 can be reliably inverted during the comparison operation and the comparison operation by the comparison unit 31 can be ensured.

After time T2, the ramp waves are given as the reference signal Ramp to the second input terminal IN2. At the timing at which the voltage of the second input terminal IN2 to which the ramp waves have been given is substantially consistent with the voltage of the first input terminal IN1[n], the comparison output of the comparison unit 31 is inverted. At a time (time T3) at which a predetermined period has elapsed after the input of the ramp waves to the second input terminal IN2 has been initiated, the reference signal generation unit 16 stops the ramp wave generation.

After the reset operation of the comparison unit 31, a difference between V_{1[n]} and V_{RST} is applied as the offset for the first input terminals IN1[1], IN1[2], and IN1[3]. Because the voltage values V_{1[}1], V_{1[}2], and V_{1[}3] are different from each other, different offsets are applied to the first input terminals IN1[1], IN1[2], and IN1[3]. Voltages V_{1[n]} of the first input terminals IN1[1], IN1[2], and IN1[3] at the initiation of comparison in the comparison unit 31 according to the first read operation are different from each other. Thereby, even when the timings of the comparison starts in the comparison units 31 according to the first read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

Subsequently, the signal level serving as the pixel signal Pixel from the unit pixel 3 is given to the first input terminal IN1[n]. Hereinafter, the voltage of the first input terminal IN1[n] at a time (time T4) when the signal level is input will be described. Hereinafter, a parasitic capacitor CP between the first input terminal IN1[n] and the ground GND will be assumed and described.

At a time (time T2) when the voltage of the first input terminal IN1[n] has been changed from V_{RST} to V_{1[n]} by the switch element SW5, the voltage of the other end of the capacitive element C1 to which the reset level is given as the pixel signal Pixel is V_{R}. In addition, at a time (time T4) when the signal level has been input as the pixel signal Pixel, the voltage of the other end of the capacitive element C1 is represented by V_{S}. When voltage variation of the other end of the capacitive element C1 from time T2 to time T4 is represented by ΔV5, ΔV5 is represented by the following Equation (15).

ΔV5=V_{S}−V_{R} (15)

Because the transistor P6 and the switch element SW5 are in the OFF state during the period from time T2 to time T4, an amount of charges accumulated in the capacitive element C1 and the parasitic capacitor CP is retained. Thus, when voltage variation of the first input terminal IN1[n] from time T2 to time T4 is represented by ΔV6, ΔV6 is represented by the following Equation (16). Furthermore, in Equation (16), C_{P} is a capacitance value of the parasitic capacitor CP.

$$Δ V 6 = \frac{{C}_{1}}{{C}_{1} + {C}_{P}} \times Δ V 5 \qquad ( 16 )$$

When C_{P} is negligible compared to C₁ (C₁>>C_{P}), ΔV6=ΔV5. Because the voltage of the first input terminal IN1[n] at time T2 is V_{1[n]}, the voltage V_{IN1[}1] of the first input terminal IN1[n] at time T4 is represented by the following Equation (17).

$$\begin{matrix}{V}_{IN 1 [ n ]} = {V}_{1 [ n ]} + Δ V 6 \\ = {V}_{1 [ n ]} + Δ V 5 \\ = {V}_{1 [ n ]} + ( {V}_{S} - {V}_{R} )\end{matrix} \qquad ( 17 )$$

Because V_{1[n]}<V_{RST} and V_{S}≦V_{R}, the voltage (Equation (17)) of the first input terminal IN1[n] at the initiation of comparison in the comparison unit 31 according to the second read operation is lower than the voltage V_{RST} of the second input terminal IN2. As illustrated in FIG. 13, the ramp wave, which decreases with the passage of time, is given as the reference signal Ramp, so that the output of the comparison unit 31 can be reliably inverted during the comparison operation and the comparison operation by the comparison unit 31 can be ensured.

After time T4, the ramp waves are given as the reference signal Ramp to the second input terminal IN2. At the timing at which the voltage of the second input terminal IN2 to which the ramp waves have been given is substantially consistent with the voltage of the first input terminal IN1[n], the comparison output of the comparison unit 31 is inverted. At a time (time T5) at which a predetermined period has elapsed after the input of the ramp waves to the second input terminal IN2 has been initiated, the reference signal generation unit 16 stops the ramp wave generation. Because the measurement unit 32 performs measurement in the count-down mode during the first read operation and the measurement unit 32 performs measurement in the count-up mode during the second read operation, a measurement value related to the second term of the right side of Equation (17) is obtained as a measurement value of the measurement unit 32.

As described above, the voltage values V_{1[}1], V_{1[}2], and V_{1[}3] are different from each other. In addition, usually, the reset levels output from the unit pixels 3 of each column are substantially the same and signal levels are different. Thus, usually, voltages V_{IN1[}1], V_{IN1[}2], and V_{IN1[}3] (Equation (17)) of the first input terminals IN1[1], IN1[2], and IN1[3] at the initiation of comparison in the comparison unit 31 according to the second read operation are different from each other. Thereby, even when the timings of the comparison starts in the comparison units 31 according to the second read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

As described above, according to the fifth preferred embodiment, the change unit 18e (the switch element SW5) changes the voltage of the first input terminal N1 to a lower voltage so that a voltage difference between the first input terminal N1 and the second input terminal IN2 becomes a voltage that ensures the comparison operation by the comparison unit 31 after the reset operation by the transistors P6 and P7. Thereby, the comparison unit 31 can reliably perform the comparison operation between the reference signal Ramp and the pixel signal Pixel.

In addition, because a different offset is applied to the first input terminal IN1 of the comparison unit 31 for each of the areas 39a, 39b, and 39c, it is possible to cause the comparison units 31 to end comparisons at different timings even when the comparison units 31 in the column AD conversion units 30 of each of the areas 39a, 39b, and 39c have substantially simultaneously started comparisons. Thereby, it is possible to perform AD conversion with higher precision because the power concentration is reduced.

In addition, it is possible to easily configure the change unit 18e by connecting the change unit 18e to a different voltage source for each of the areas 39a, 39b, and 39c.

### Sixth Preferred Embodiment

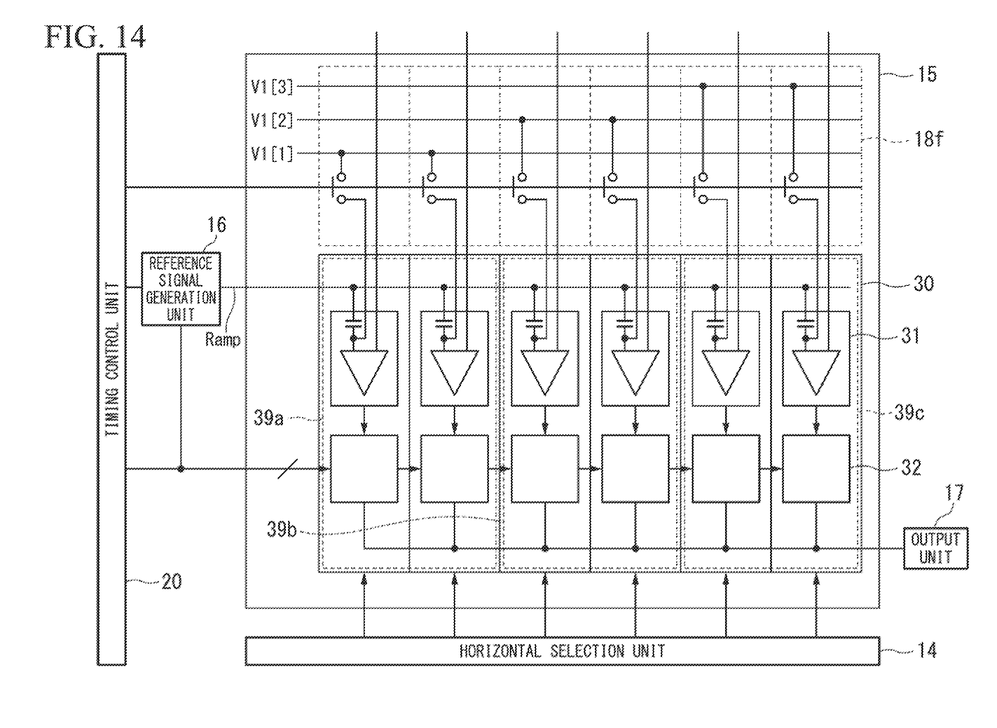

Next, the sixth preferred embodiment of the present invention will be described. In the sixth preferred embodiment, the change unit is different from that of the first preferred embodiment. FIG. 14 illustrates an example of a configuration of a column processing unit 15 including a column AD conversion unit 30 and a change unit 18f. Because other components are substantially the same as those illustrated in FIG. 1, a description thereof is omitted here.

The change unit 18f includes a switch element. One end of the switch element is connected to the second input terminal of the comparison unit 31, and the other end of the switch element is connected to a voltage source V1[n] (n: Ito 3). The voltage source V1[1] supplies a power supply voltage (voltage value: V_{1[}1]) to the change unit 18f corresponding to the column AD conversion unit 30 of the area 39a. The voltage source V1[2] supplies a power supply voltage (voltage value: V_{1[}2]) to the change unit 18f corresponding to the column AD conversion unit 30 of the area 39b. The voltage source V1[3] supplies a power supply voltage (voltage value: V_{1[}3]) to the change unit 18f corresponding to the column AD conversion unit 30 of the area 39c. The relationship of the voltage values V_{1[n]} (n: 1 to 3), for example, is V_{1[}1]>V_{1[}2]>V_{1[}3]. Furthermore, these are exemplary examples and the present invention is not limited thereto here.

Because operations of the column AD conversion unit 30 and the change unit 18f during the first and second read operations are substantially the same as those of the column AD conversion unit 30 and the change unit 18 in the first preferred embodiment, a description thereof is omitted here.

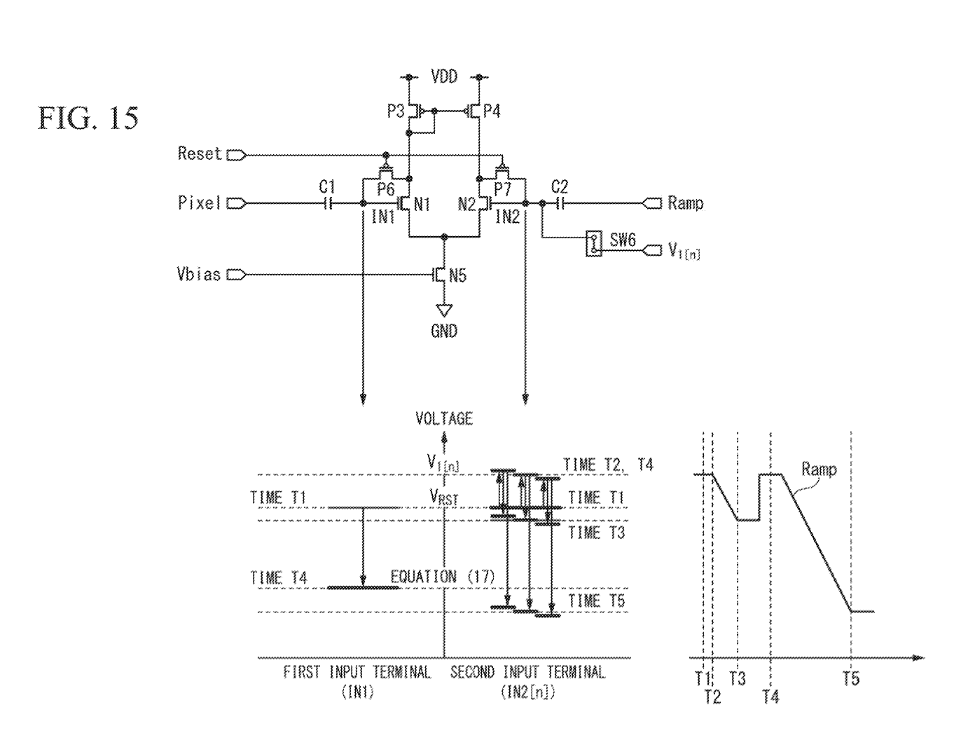

Next, details of configurations of the comparison unit 31 and the change unit 18f and voltage variations in the input terminals of the comparison unit 31 will be described. FIG. 15 illustrates an example of specific circuit configurations of the comparison unit 31 and the change unit 18f. Hereinafter, only parts different from those of the first preferred embodiment in the circuit configurations of this example will be described here.

The change unit 18f includes a switch element SW6. One end of the switch element SW6 is connected to the gate of the transistor N2, and the other end of the switch element SW6 is connected to a voltage source V1[n] (n: 1 to 3). According to a control signal (not illustrated) from the timing control unit 20, ON and OFF states of the switch element SW6 are controlled.

Hereinafter, an operation of this example will be described. Herein, a voltage of the voltage source V1[n] is represented by V_{1[n]}, a reset-level voltage is represented by V_{R}, a signal-level voltage is represented by V_{S} (here, V_{S}≦V_{R}), and a capacitance value of the capacitive element C2 is represented by C₂. In addition, the second input terminal IN2 of the differential amplifier connected to the voltage source V1[n] via the switch element SW6 is represented by a second input terminal IN2[n] (n: 1 to 3). In FIG. 15, voltage variations of the first input terminal IN1 and the second input terminal IN2[n] of the differential amplifier within the comparison unit 31 and a waveform of the reference signal Ramp are illustrated.

Once the reset level serving as the pixel signal Pixel from the unit pixel 3 is given to the first input terminal IN1 and the reference signal Ramp given from the reference signal generation unit 16 to the second input terminal IN2[n] is stable, the timing control unit 20 activates a reset pulse Reset (low active) before the comparison start of the comparison unit 31. Thereby, the transistors P6 and P7 are in the ON state, the gates and the drains of the transistors N1 and N2 are short-circuited, and the voltages of the two input terminals are reset by designating operation points of the transistors N1 and N2 as drain voltages. During the reset operation, the switch element SW6 is in the OFF state and the other end of the switch element SW6 is separated from the voltage source V1[n].

At the operation points determined by the reset operation, offset components of the voltages of the two input terminals of the differential amplifier, that is, the gate voltages of the transistors N1 and N2, are almost canceled. That is, the voltages of the two input terminals of the differential amplifier are reset to be substantially the same voltage V_{RST}. At this time (time T1), the voltage of the first input terminal IN1 is V_{RST} and the voltage of the second input terminal IN2[n] is V_{RST}. After the reset operation, the transistors P6 and P7 are in the OFF state.

Subsequently, the switch element SW6 changes from being in the OFF state to being in the ON state, so that the voltage of the second input terminal IN2[n] to which the pixel signal Pixel is given, that is, the gate voltage of the transistor N2, is increased and changed from the voltage V_{RST} to a predetermined voltage. At this time (time T2), the voltage of the first input terminal IN1 is V_{RST} and the voltage of the second input terminal IN2[n] is V_{1[n]}. Here, the relationship between the voltage V_{1[n]} of the voltage source V1[n] and the reset voltage V_{RST} is V_{RST}<V_{1[n]}. The switch element SW6 is in the OFF state after being in the ON state.

Because V_{RST}<V_{1[n]} even when some variation remains in the voltages of the two input terminals of the differential amplifier constituting the comparison unit 31 after the reset operation of the comparison unit 31, the voltage V_{1[n]} of the second input terminal IN2[n] at the initiation of comparison in the comparison unit 31 according to the first read operation is higher than the voltage V_{RST} of the first input terminal IN1. As illustrated in FIG. 13, the ramp wave, which decreases with the passage of time, is given as the reference signal Ramp, so that the output of the comparison unit 31 can be reliably inverted during the comparison operation and the comparison operation by the comparison unit 31 can be ensured.

After time T2, the ramp waves are given as the reference signal Ramp to the second input terminal IN2[n]. At the timing at which the voltage of the second input terminal IN2[n] to which the ramp waves have been given is substantially consistent with the voltage of the first input terminal N1, the comparison output of the comparison unit 31 is inverted. At a time (time T3) at which a predetermined period has elapsed after the input of the ramp waves to the second input terminal IN2[n] has been initiated, the reference signal generation unit 16 stops the ramp wave generation.

After the reset operation of the comparison unit 31, a difference between V_{1[n}] and V_{RST} is applied as the offset for the second input terminals IN2[1], IN2[2], and IN2[3]. Because the voltage values V_{1[}1], V_{1[}2], and V_{1[}3] are different from each other, different offsets are applied to the second input terminals IN2[1], IN2[2], and IN2[3]. Voltages V_{1[n]} l of the second input terminals IN2[1], IN2[2], and IN2[3] at the initiation of comparison in the comparison unit 31 according to the first read operation are different from each other. Thereby, even when the timings of the comparison starts in the comparison units 31 according to the first read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

Subsequently, the signal level serving as the pixel signal Pixel from the unit pixel 3 is given to the first input terminal IN1. The voltage V_{IN1} of the first input terminal IN1 at this time (time T4) is represented by the following Equation (18) as in Equation (9) in the second preferred embodiment.

V_{IN1}=V_{RST}+(V_{S}−V_{R}) (18)

The voltage of the second input terminal IN2[n] is V_{1[n]} l at a time (time T4) at which the signal level has been input. Because V_{RST}<V_{1[n]} and V_{S}≦V_{R}, the voltage V_{1[n]} of the second input terminal IN2[n] at the initiation of comparison in the comparison unit 31 according to the second read operation is higher than the voltage V_{RST} of the first input terminal IN1. As illustrated in FIG. 13, the ramp wave, which decreases with the passage of time, is given as the reference signal Ramp, so that the output of the comparison unit 31 can be reliably inverted during the comparison operation and the comparison operation by the comparison unit 31 can be ensured.

After time T4, ramp waves are given as the reference signal Ramp to the second input terminal IN2[n]. Hereinafter, a voltage of the second input terminal IN2[n] to which the ramp waves have been given will be described. Hereinafter, a parasitic capacitor CP between the second input terminal IN2[n] and the ground GND will be assumed and described.

If voltage variation of the other end of the capacitive element C2 is represented by ΔV7 when a voltage of the ramp waves given to the other end of the capacitive element C2 has been changed from V_{Ramp}(0) to V_{Ramp}(t) by (V_{Ramp}(0−V_{Ramp}(0)), ΔV7 is represented by the following Equation (19).

ΔV7=V_{Ramp}(t)−V_{Ramp}(0) (19)

Because the transistor P7 is in the OFF state during the period from time T2 to time T4, the amount of charges accumulated in the capacitive element C2 and the parasitic capacitor CP is retained. If voltage variation of the second input terminal IN2[n] is represented by ΔV8 when a voltage of the ramp waves given to the other end of the capacitive element C2 has been changed from V_{Ramp}(0) to V_{Ramp}(t) by (V_{Ramp}(t)−V_{Ramp}(0)), ΔV8 is represented by the following Equation (20).

Furthermore, in Equation (20), C_{P} is a capacitance value of the parasitic capacitor CP.

$$Δ V 8 = \frac{{C}_{2}}{{C}_{2} + {C}_{P}} \times Δ V 7 \qquad ( 20 )$$

When C_{P} is negligible compared to C₂ (C₂>>C_{P}), ΔV7=ΔV8. Because the voltage of the second input terminal IN2[n] at time T4 is V_{1[n]}, the voltage V_{IN1[}1] of the second input terminal IN2[n] after time T4 is represented by the following Equation (21).

$$\begin{matrix}{V}_{IN 2 [ n ]} = {V}_{1 [ n ]} + Δ V 8 \\ = {V}_{1 [ n ]} + Δ V 7 \\ = {V}_{1 [ n ]} + ( {V}_{Ramp} ( t ) - {V}_{Ramp} ( 0 ) )\end{matrix} \qquad ( 21 )$$

At the timing at which the voltage of the second input terminal IN2[n] to which the ramp waves have been given is substantially consistent with the voltage of the first input terminal N1, the comparison output of the comparison unit 31 is inverted. At a time (time T5) at which a predetermined period has elapsed after the input of the ramp waves to the second input terminal IN2 has been initiated, the reference signal generation unit 16 stops the ramp wave generation. Because the measurement unit 32 performs measurement in the count-down mode during the first read operation and the measurement unit 32 performs measurement in the count-up mode during the second read operation, a measurement value related to the second term of the right side of Equation (18) is obtained as a measurement value of the measurement unit 32.

As described above, the voltages V_{IN2[}1], V_{IN2[}2], and V_{IN2[}3] of the second input terminals IN2[1], IN2[2], and IN2[3] at the initiation of comparison in the comparison unit 31 according to the second read operation are V_{1[n]} and are different from each other. Thereby, even when the timings of the comparison starts in the comparison units 31 according to the second read operation are substantially the same, the timing of the comparison end is different in the comparison unit 31 of the column AD conversion unit 30 of each of the areas 39a, 39b, and 39c. As described above, the comparison unit 31 ends the comparison operation at a different timing for each of the areas 39a, 39b, and 39c, so that it is possible to perform AD conversion with higher precision because power concentration is reduced.

As described above, according to the sixth preferred embodiment, the change unit 18f (the switch element SW6) changes the voltage of the second input terminal IN2 to a higher voltage so that a voltage difference between the first input terminal IN1 and the second input terminal IN2 becomes a voltage that ensures the comparison operation by the comparison unit 31 after the reset operation by the transistors P6 and P7. Thereby, the comparison unit 31 can reliably perform the comparison operation between the reference signal Ramp and the pixel signal Pixel.

In addition, because a different offset is applied to the second input terminal IN2 of the comparison unit 31 for each of the areas 39a, 39b, and 39c, it is possible to cause the comparison units 31 to end comparisons at different timings even when the comparison units 31 in the column AD conversion units 30 of each of the areas 39a, 39b, and 39c have substantially simultaneously started comparisons. Thereby, it is possible to perform AD conversion with higher precision because power concentration is reduced.

In addition, it is possible to easily configure the change unit 18f by connecting the change unit 18f to a different voltage source for each of the areas 39a, 39b, and 39c.

The present invention provides an image pickup device capable of performing AD conversion with higher precision.

According to the first preferred embodiment of the present invention, an offset that a change unit of an AD conversion unit connected to a column signal line corresponding to one column of an array of unit pixels included in a first pixel group applies to a first input terminal or a second input terminal of a comparison unit is different from an offset that a change unit of an AD conversion unit connected to a column signal line corresponding to one column of an array of unit pixels included in a second pixel group applies to a first input terminal or a second input terminal of a comparison unit, so that it is possible to cause each comparison unit to end comparison at a different timing. Thereby, it is possible to perform AD conversion with higher precision because power concentration is reduced.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. An image pickup device comprising:
an image capturing unit in which a plurality of unit pixels having photoelectric conversion elements are arranged in a matrix shape, the image capturing unit being configured to output an analog signal to a column signal line corresponding to each column of an array of the unit pixels;
a reference signal generation unit configured to generate a reference signal to be increased or decreased with passage of time;
a row selection unit configured to select and control each unit pixel of the image capturing unit for every row of the array of the unit pixels;
a comparison unit that includes a differential amplifier unit and a reset unit, the differential amplifier unit including a first input terminal electrically connected to the column signal line via a first capacitive element and a second input terminal electrically connected to the reference signal generation unit, the differential amplifier unit being configured to compare a voltage of the first input terminal to a voltage of the second input terminal, the reset unit being configured to reset the voltages of the first and second input terminals;
a measurement unit configured to measure a comparison time of the comparison unit from a comparison start to a comparison end; and
a change unit that includes a switch element and a second capacitive element in which one end of the second capacitive element is connected to the first input terminal and the other end of the second capacitive element is connected to a first voltage source via the switch element at a time of a reset operation by the reset unit and connected to a second voltage source different from the first voltage source via the switch element after the reset operation by the reset unit, the change unit being configured to apply an offset corresponding to voltages of the first voltage source and the second voltage source to the first input terminal so that a voltage difference between the first and second input terminals becomes a voltage that ensures a comparison operation by the comparison unit, wherein
the plurality of unit pixels arranged in the image capturing unit include unit pixels included in a first pixel group and unit pixels included in a second pixel group different from the first pixel group, and
the offset to be applied to the first input terminal of the comparison unit connected to the column signal line corresponding to one column of an array of the unit pixels included in the first pixel group is different from the offset to be applied to the first input terminal of the comparison unit connected to the column signal line corresponding to one column of an array of the unit pixels included in the second pixel group.

2. The image pickup device according to claim 1, wherein a capacitance value of the second capacitive element provided in the change unit related to the comparison unit connected to the column signal line corresponding to the one column of the array of the unit pixels included in the first pixel group is different from a capacitance value of the second capacitive element provided in the change unit related to the comparison unit connected to the column signal line corresponding to the one column of the array of the unit pixels included in the second pixel group.

3. The image pickup device according to claim 1, wherein a voltage value of at least one voltage source of the first and second voltage sources connected to the other end of the second capacitive element provided in the change unit related to the comparison unit connected to the column signal line corresponding to the one column of the array of the unit pixels included in the first pixel group is different from a voltage value of at least one voltage source of the first and second voltage sources connected to the other end of the second capacitive element provided in the change unit related to the comparison unit connected to the column signal line corresponding to the one column of the array of the unit pixels included in the second pixel group.

4. The image pickup device according to claim 1, wherein the second voltage source is the analog signal.

5. An image pickup device comprising:
an image capturing unit in which a plurality of unit pixels having photoelectric conversion elements are arranged in a matrix shape, the image capturing unit being configured to output an analog signal to a column signal line corresponding to each column of an array of the unit pixels;
a reference signal generation unit configured to generate a reference signal to be increased or decreased with passage of time;
a row selection unit configured to select and control each unit pixel of the image capturing unit for every row of the array of the unit pixels;
a comparison unit that includes a differential amplifier unit and a reset unit, the differential amplifier unit including a first input terminal electrically connected to the column signal line and a second input terminal electrically connected to the reference signal generation unit via a first capacitive element, the differential amplifier being configured to compare a voltage of the first input terminal to a voltage of the second input terminal, the reset unit being configured to reset the voltages of the first and second input terminals;
a measurement unit configured to measure a comparison time of the comparison unit from a comparison start to a comparison end; and
a change unit that includes a switch element and a second capacitive element in which one end of the second capacitive element is connected to the second input terminal and the other end of the second capacitive element is connected to a first voltage source via the switch element at a time of a reset operation by the reset unit and connected to a second voltage source different from the first voltage source via the switch element after the reset operation by the reset unit, the change unit applying an offset corresponding to voltages of the first voltage source and the second voltage source to the second input terminal so that a voltage difference between the first and second input terminals becomes a voltage which ensures a comparison operation by the comparison unit, wherein
the plurality of unit pixels arranged in the image capturing unit include unit pixels included in a first pixel group and unit pixels included in a second pixel group different from the first pixel group, and
the offset to be applied to the second input terminal of the comparison unit connected to the column signal line corresponding to one column of an array of the unit pixels included in the first pixel group is different from the offset to be applied to the second input terminal of the comparison unit connected to the column signal line corresponding to one column of an array of the unit pixels included in the second pixel group.

6. The image pickup device according to claim 5, wherein a capacitance value of the second capacitive element provided in the change unit related to the comparison unit connected to the column signal line corresponding to the one column of the array of the unit pixels included in the first pixel group is different from a capacitance value of the second capacitive element provided in the change unit related to the comparison unit connected to the column signal line corresponding to the one column of the array of the unit pixels included in the second pixel group.

7. The image pickup device according to claim 5, wherein a voltage value of at least one voltage source of the first and second voltage sources connected to the other end of the second capacitive element provided in the change unit related to the comparison unit connected to the column signal line corresponding to the one column of the array of the unit pixels included in the first pixel group is different from a voltage value of at least one voltage source of the first and second voltage sources connected to the other end of the second capacitive element provided in the change unit related to the comparison unit connected to the column signal line corresponding to the one column of the array of the unit pixels included in the second pixel group.

8. The image pickup device according to claim 5, wherein the second voltage source is the reference signal.

9. An image pickup device comprising:
an image capturing unit in which a plurality of unit pixels having photoelectric conversion elements are arranged in a matrix shape, the image capturing unit being configured to output an analog signal to a column signal line corresponding to each column of an array of the unit pixels;
a reference signal generation unit configured to generate a reference signal to be increased or decreased with passage of time;
a row selection unit configured to select and control each unit pixel of the image capturing unit for every row of the array of the unit pixels;
a comparison unit that includes a differential amplifier unit and a reset unit, the differential amplifier unit including a first input terminal electrically connected to the column signal line via a first capacitive element and a second input terminal electrically connected to the reference signal generation unit, the differential amplifier being configured to compare a voltage of the first input terminal to a voltage of the second input terminal, the reset unit being configured to reset the voltages of the first and second input terminals;
a measurement unit configured to measure a comparison time of the comparison unit from a comparison start to a comparison end; and
a change unit that includes a switch element in which one end of the switch element is connected to the first input terminal and the other end of the switch element is connected to a voltage source after a reset operation by the reset unit, the changing unit being configured to apply an offset corresponding to a voltage of the voltage source to the first input terminal so that a voltage difference between the first and second input terminals becomes a voltage which ensures a comparison operation by the comparison unit, wherein
the plurality of unit pixels arranged in the image capturing unit include unit pixels included in a first pixel group and unit pixels included in a second pixel group different from the first pixel group, and
the offset to be applied to the first input terminal of the comparison unit connected to the column signal line corresponding to one column of an array of the unit pixels included in the first pixel group is different from the offset to be applied to the first input terminal of the comparison unit connected to the column signal line corresponding to one column of an array of the unit pixels included in the second pixel group.

10. The image pickup device according to claim 9, wherein a voltage value of the voltage source connected to the other end of the switch element provided in the change unit related to the comparison unit connected to the column signal line corresponding to one column of an array of the unit pixels included in the first pixel group is different from a voltage value of the voltage source connected to the other end of the switch element provided in the change unit related to the comparison unit connected to the column signal line corresponding to one column of an array of the unit pixels included in the second pixel group.

11. An image pickup device comprising:
an image capturing unit in which a plurality of unit pixels having photoelectric conversion elements are arranged in a matrix shape, the image capturing unit being configured to output an analog signal to a column signal line corresponding to each column of an array of the unit pixels;
a reference signal generation unit configured to generate a reference signal to be increased or decreased with passage of time;
a row selection unit configured to select and control each unit pixel of the image capturing unit for every row of the array of the unit pixels;
a comparison unit that includes a differential amplifier unit and a reset unit, the differential amplifier unit including a first input terminal electrically connected to the column signal line and a second input terminal electrically connected to the reference signal generation unit via a first capacitive element, the differential amplifier being configured to compare a voltage of the first input terminal to a voltage of the second input terminal, the reset unit being configured to reset the voltages of the first and second input terminals;
a measurement unit configured to measure a comparison time of the comparison unit from a comparison start to a comparison end; and
a change unit that includes a switch element in which one end of the switch element is connected to the second input terminal and the other end of the switch element is connected to a voltage source after a reset operation by the reset unit, the change unit applying an offset corresponding to a voltage of the voltage source to the second input terminal so that a voltage difference between the first and second input terminals becomes a voltage which ensures a comparison operation by the comparison unit, wherein
the plurality of unit pixels arranged in the image capturing unit include unit pixels included in a first pixel group and unit pixels included in a second pixel group different from the first pixel group, and
the offset to be applied to the second input terminal of the comparison unit connected to the column signal line corresponding to one column of an array of the unit pixels included in the first pixel group is different from the offset to be applied to the second input terminal of the comparison unit connected to the column signal line corresponding to one column of an array of the unit pixels included in the second pixel group.

12. The image pickup device according to claim 11, wherein a voltage value of the voltage source connected to the other end of the switch element provided in the change unit related to the comparison unit connected to the column signal line corresponding to one column of an array of the unit pixels included in the first pixel group is different from a voltage value of the voltage source connected to the other end of the switch element provided in the change unit related to the comparison unit connected to the column signal line corresponding to one column of an array of the unit pixels included in the second pixel group.
